(19) United States
(12) Patent Application Publication
(10) Pub. No.: US 2007/0123342 A1
(43) Pub. Date: May 31, 2007

(54) Gaming machine

(75) Inventors: Takaaki Hishinuma, Tokyo (JP); Takayuki Hirauchi, Tokyo (JP); Yousuke Kamada, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/377,931

(22) Filed: Mar. 17, 2006

(30) Foreign Application Priority Data
Nov. 30, 2005 (JP) 2005-346362

(51) Int. Cl. A63F 13/00

(52) U.S. Cl. 463/20

(57) ABSTRACT

Disclosed is a gaming machine. The gaming machine comprises a RT game-number counter for storing the information of the number (200 times, 100 times, 50 times, etc.) of unit games provided to correspond to each of the plural symbol combinations, on condition that all of RT1, RT2 and RT3 corresponding to each of “Bell-Bell-Red 7,” “Bell-Bell-Blue 7” and “Bell-Bell-BAR” are determined, on condition of the detection of one start operation carried out by the start switch 6S, by the main control circuit 71 and one of the symbol combinations is displayed by the symbol display areas 21L, 21C, 21R.

### CROSS-REFERENCE TO RELATED APPLICATIONS

This application is related to a Japanese Patent Application No. 2005-34 6362, filed on Nov. 30, 2005

### BACKGROUND OF THE INVENTION

1. Field of the Invention

The present invention relates to a gaming machine.

2. Description of Related Art

A slot machine, so-called pachi-slot machine having a stop button comprises a variable display device having plural mechanical rotation reels for displaying symbols in a front display window, or an electrical variable display device for displaying symbols arranged on a reel on a screen. Control means drives the variable display device in accordance with a start operation of a player to rotate each of the reels, thereby variably displaying the symbols. After a predetermined time period, the control means sequentially stops the rotations of the reels automatically or in accordance with a stop operation of the player. At this time, when the symbols of the respective reels displayed in the display window form a specific combination (winning symbols), a game medium such as coin, medal, etc. is paid out to award a payout the player.

At present, the machine forming a mainstream has plural types of winning modes. In particular, when a winning of a predetermined combination is made (determined), a gaming state is provided in which a condition is better than a base state during a predetermined time period, in addition to the payout of the coin of one time. As the combination, there are a combination allowing a game, in which a relatively large payout is awarded to a player, to be carried out for the predetermined number of times (which is referred to as “big bonus” and abbreviated to “BB”), and a combination allowing a game, in which a relatively small payout is awarded to a player, to be carried out for the predetermined number of games (which is referred to as “regular bonus” and abbreviated to “RB”).

In addition, in the machine forming a mainstream, it is required that a winning of a combination should be determined (hereinafter, referred to as “internal winning”) by an internal lottery process (hereinafter, referred to as “internal lottery”) and a player should carry out a stop operation at a timing at which a combination of symbols representing a winning establishment of the combination internally won (hereinafter, referred to as “internal winning combination”) can be stopped on an activated pay line (hereinafter, referred to as “activated line”) so that a combination of predetermined symbols is arranged along the activated line and a winning enabling a coin, medal and the like to be paid out is made. Accordingly, even though the internal winning is determined, a winning cannot be made unless the player carries out the stop operation at the proper timing. In other words, in the gaming machine forming a mainstream, it is required an experienced skill with regard to the timing of the stop operation (i.e., it is high a portion of a technique intervention characteristic called as an “observation push”).

Regarding the above machine, it has been suggested a gaming machine for the purpose of providing a new game capable of changing probability tables, thereby allowing a player to have fun, as disclosed in a Japanese Patent Unexamined Publication No. 2001-137430. According to this gaming machine, after a special game is over, it is possible to continue a game in which the number of medals obtained in a previous special game is not reduced, for example the number of medals possessed is nearly maintained, until it is made a special combination next time. As a consequence, it is possible to provide a state which is more advantageous to the player.

However, according to the above gaming machine, a gaming state, in which a lottery of the combination is conducted with a replay high-probability lottery table, is started when the special game (bonus) is over, and is over after the predetermined number of games is played. Accordingly, since the gaming state is started in which the player can use the replay high-probability lottery table to conduct a lottery of the combination, without relying on the thinking or will, the game becomes monotonous and the player may lose an interest in a game.

### SUMMARY OF THE INVENTION

An object of the invention is to provide a gaming machine capable of excluding a source causing a game to be monotonous and a source causing a player to lose an interest in a game.

In order to achieve the above object, there is provided a gaming machine in which a kind of each of symbols constituting each of plural symbol combinations is different with regard to only a symbol in one of plural rows, the number of symbols capable of being successively displayed by symbol display means in the one row is different, the information of the number of unit games provided to correspond to each of the plural symbol combinations is such constituted that the information of unit games corresponding to a symbol combination constituted by the smaller number of symbols, among the plural symbol combinations, is more than the information of unit games corresponding to a symbol combination constituted by the greater number of symbols, among the plural symbol combinations, and means for determining an internal winning combination determines an internal winning combination, based on the second internal winning combination determining information, while the unit games are conducted as the information of the number of unit games stored by means for storing the information of the number of times.

More specifically, the invention provides the following gaming machines.

(1) There is provided a gaming machine comprising: symbol display means (for example, reels 3L, 3C, 3R, symbol display areas 21L, 21C, 21R) for displaying symbols in plural rows (for example, three rows); start operation detection means (for example, start switch 6S, main control circuit 71) for detecting a start operation (for example, start operation, operation of a start lever 6) by a player; internal winning combination determination (for example, means for carrying out an internal lottery process, main control circuit 71) for determining an internal winning combination (for example, internal carryover combination, etc.), based on internal winning combination determining information (for example, internal lottery table), on condition that the start operation is detected by the start operation detection means; symbol varying means (for example, stepping motors 49L, 49C, 49R, main control circuit 71) for varying (for example, variably displaying) symbols to be displayed in the plural rows by the symbol display means, on condition that the start operation is detected by the start operation detection means; stop operation detection (for example, stop switches 7LS, 7CS, 7RS) for detecting a stop operation (for example, operation of stop buttons 7L, 7C, 7R) by the player; stop control means (for example, means for carrying out a reel stop control process, main control circuit 71) for carrying out a stop control of the symbol variation carried out by the symbol varying means, based on the detection of the stop operation carried out by the stop operation detection means and an internal winning combination determined by the internal winning combination determining means; and number information storing means (for example, RT game-number counter, RAM 33) for storing information of the number of unit games (for example, 200, 100, 50 and the like) provided to correspond to each of the plural symbol combinations, on condition that all internal winning combinations (for example, RT1, RT2, RT3 and the like) corresponding to each of predetermined plural symbol combinations (for example, “Bell-Bell-Red 7,” “Bell-Bell-Blue 7,” “Bell-Bell-BAR”) are determined, on condition of the detection of one start operation carried out by the start operation detection means, by the internal winning combination determining means and one of the plural symbol combinations is displayed by the symbol display means (for example, on condition that a determination result in one of steps S161, S163 and S165 of FIG. 28 is YES), wherein the internal winning combination determining information provided for the internal winning combination determining means to determine an internal winning combination comprises the first internal winning combination determining information (for example, internal lottery table for a normal gaming state) in which a probability that a specific combination (for example, Replay), in which a specific symbol combination (for example, “Replay-Replay-Replay”) is matched to a payout allowing the player to play a unit game without consuming a game value (for example, medal), will be determined is a first probability (for example, “8980/65536”), and the second internal winning combination determining information (for example, internal lottery table in which only the upper limit (“61513”) corresponding to a winning number “7” is different in an internal lottery table for a normal gaming state) in which the probability that the specific combination will be determined is a second probability (for example, “55465/65536”) greater than the first probability, wherein a kind of each (for example, “Bell,” “Red 7,” “Blue 7,” “BAR,” etc.) of symbols constituting each of the plural symbol combinations is different with regard to only a symbol (for example, “Red 7,” “Blue 7” and “BAR”) in one (for example, right reel 3R) of the plural rows, and the number of symbols capable of being successively displayed by the symbol display means in the one row is different (for example, one “Red 7” is displayed, two “Blue 7's” are successively displayed and three “BARs” are successively displayed), and wherein the information of the number of unit games provided to correspond to each of the plural symbol combinations is constituted to be different depending on the plural symbol combinations and the internal winning combination determining means determines an internal winning combination, based on the second internal winning combination determining information, while the unit games are conducted as the information of the number of unit games stored by the number information storing means (for example, during a time period of until the RT game-number counter becomes 0).

According to the gaming machine described in the above (1), a kind of each of symbols constituting each of the plural symbol combinations is different with regard to only a symbol in one of the plural rows, and the number of symbols capable of being successively displayed by the symbol display means in the one row is different. The information of the number of unit games provided to correspond to each of the plural symbol combinations is constituted to be different depending on the plural symbol combinations. The storing means stores the information of the number of unit games provided to correspond to the respective symbol combinations, on condition that all the internal winning combinations corresponding to each of the predetermined symbol combinations are determined, on condition of the detection of one start operation carried out by the start operation detection means, by the internal winning combination determining means and one of the plural symbol combinations is displayed by the symbol display means. Like this, since a kind of each of symbols constituting each of the plural symbol combinations is different with regard to only the one row and the number of symbols capable of being successively displayed by the symbol display means in the one row is different, it is easy for the player to conduct the stop operation for making a desired symbol combination, with regard to the symbol having the greater number capable of being successively displayed, and it is difficult for the player to conduct the stop operation for making a desired symbol combination, with regard to the symbol having the smaller number capable of being successively displayed. In the mean time, in case that all the internal winning combinations corresponding to the respective predetermined symbol combinations are determined by the internal winning combination determining means, the player can carry out the stop operation with the aiming of desired symbols, considering the player's own ability. In addition, the information of the number of unit games resulting from that one of the plural symbol combinations is displayed by the symbol display means is different depending on the plural symbol combinations. Accordingly, since the information of the number of times is different, which is caused by the player's decision and stop operation, it is possible to exclude a source causing the player to lose an interest in a game. In addition, since the information of the number of times is not determined in advance, it is possible to exclude a source causing a game to be monotonous.

(2) In the gaming machine described in the above (1), it is provided means (for example, means for carrying out a process in a step S33 of FIG. 18) for operating a special gaming state (for example, state in which a RB gaming state is carried out by the predetermined number of times), on condition that a predetermined symbol combination (for example, “Red 7-Red 7-Red 7,” “Blue 7-Blue 7-Blue 7,” etc.) corresponding to a predetermined combination (for example, BB1, BB2, etc.) is displayed by the symbol display means, and a probability that the predetermined combination will be determined is same in the first internal winning combination determining information and the second internal winning combination determining information.

According to the gaming machine described in the above (2), the means for operating a special gaming state operates a special gaming state, on condition that a predetermined symbol combination corresponding to a predetermined combination is displayed by the symbol display means. In addition, a probability that the predetermined combination will be determined is same in the first internal winning combination determining information and the second internal winning combination determining information. Accordingly, the player can not only play the games as the information of the number of times without consuming the game value but also play the games while expecting that the predetermined combination will be determined.

(3) In the gamine machine described in the above (1), the information of the number of unit games provided to correspond to each of the plural symbol combinations the is such constituted that the information of the number (for example, 200) of unit games corresponding to a symbol combination (for example, “Bell-Bell-Red 7”) constituted by the symbols having the smaller number capable of being successively displayed, among the plural symbol combinations, is more than the information of the number (for example, 50) of unit games corresponding to a symbol combination (for example, “Bell-Bell-BAR”) constituted by the symbols having the greater number capable of being successively displayed, among the plural symbol combinations.

According to the gaming machine described in the above (3), the information of the number of unit games resulting from that one of the plural symbol combinations is displayed by the symbol display means becomes the information of the smaller number of times, as a symbol combination constituted by the symbols having the greater number capable of being successively displayed is displayed by the symbol display means, or becomes the information of the greater number of times, as a symbol combination constituted by the symbols having the smaller number capable of being successively displayed is displayed by the symbol display means. While the unit games are carried out as the information of the number of times, the internal winning combination determining means determines an internal winning combination, based on the second internal winning combination determining information in which the probability that the specific combination will be determined is the second probability greater than the first probability. In other words, although it is difficult for the player to conduct the stop operation for making a desired symbol combination, with regard to the symbol having the smaller number capable of being successively displayed, the desired symbol combination is displayed, so that it is provided more chances that the player will play the unit game without consuming the game value. Accordingly, the player can get more opportunities to play the unit game without consuming the game value, so that it is possible to improve the ability in the stop operation. As a consequence, it is possible to promote the improvement of the ability in the stop operation and to increase the interest in the game.

(4) In the gaming machine described in the above (1), a sliding-display-number (for example, the number of sliding symbols), which is the number of symbols to be displayed by the symbol display means during a time period from after the detection of the stop operation is carried out by the stop operation detection means until the stop control of the symbol variation is carried out by the stop control means, is constituted to be smaller with regard to the symbol having the smaller number capable of being successively displayed.

According to the gaming machine described in the above (4), since it is possible to further adjust the degree of difficulty of the stop operation making it possible to form a symbol combination which the player wants, it is possible to increase the variety of the game.

### BRIEF DESCRIPTION OF THE DRAWINGS

Other and further objects, features and advantages of the invention will appear more fully from the following description taken in connection with the accompanying drawings, in which:

FIG. 1 is a perspective view showing an external appearance of a gaming machine according to an embodiment of the invention;

FIG. 2 shows a panel display unit, a liquid crystal display unit and a fixed display unit of a liquid crystal display device;

FIG. 3 is a perspective view showing a schematic structure of a liquid crystal display device;

FIG. 4 is a view showing an example of symbols arranged on reels;

FIG. 5 is a block diagram of an electric circuit;

FIG. 6 shows a display example of a liquid crystal display unit 2b;

FIG. 7 shows a symbol arrangement table;

FIG. 8 shows a symbol combination table;

FIG. 9 shows an internal lottery table determining table;

FIG. 10A shows an internal lottery table for a normal gaming state;

FIG. 10B shows an internal lottery table for a RB gaming state;

FIG. 11 shows an internal winning combination determining table;

FIG. 12 is a reel stop beginning determination table;

FIG. 13 shows a priority attraction-in ranking table;

FIG. 14 shows a bonus operation table;

FIG. 15A shows an internal winning combination 1 storing area;

FIG. 15B shows an internal winning combination 2 storing area;

FIG. 15C shows an internal carryover combination storing area;

FIG. 15D shows a random number value storing area;

FIG. 16 is a main flow chart of a main control circuit;

FIG. 17 is a flow chart following FIG. 18;

FIG. 18 is a flow chart showing a bonus operation supervisory process;

FIG. 19 is a flow chart showing a medal insertion•start checking process;

FIG. 20 is a flow chart showing a gaming state supervisory process;

FIG. 21 is a flow chart showing an internal lottery process;

FIG. 22 is a flow chart following FIG. 21;

FIG. 23 is a flow chart showing a reel stop initialization process;

FIG. 24 is a flow chart showing a reel stop control process;

FIG. 25 is a flow chart showing a display combination retrieving process;

FIG. 26 is a flow chart showing a bonus end checking process;

FIG. 27 is a flow chart showing a bonus operation checking process;

FIG. 28 is a flow chart showing a RT operation checking process; and

FIG. 29 is a flow chart showing an intervention process under control of a main CPU.

### DESCRIPTION OF THE PREFERRED EMBODIMENTS

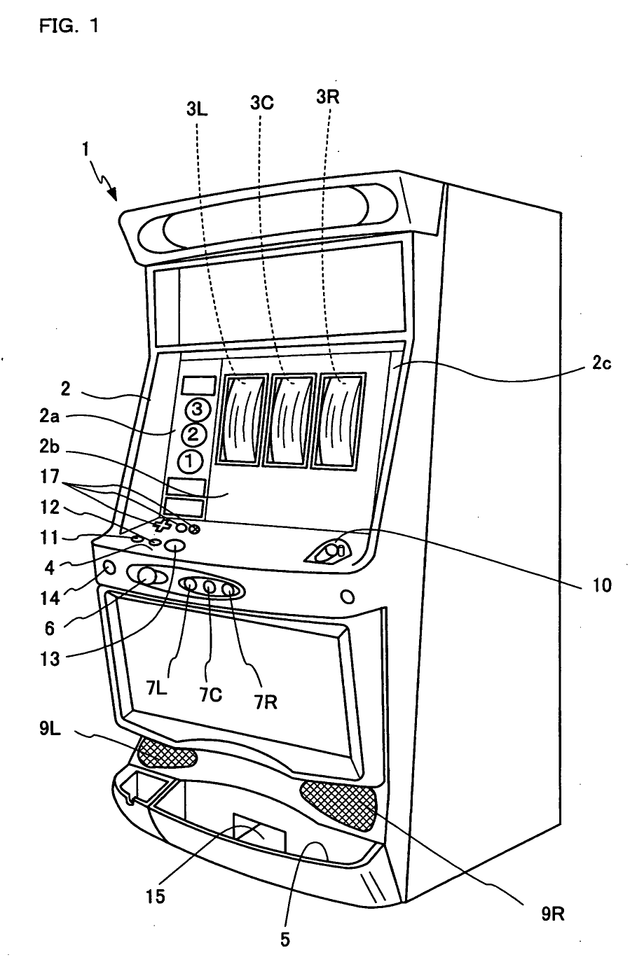

FIG. 1 is a perspective view showing an external appearance of a gaming machine 1 according to an embodiment of the invention. The gaming machine 1 is a so-called pachi-slot machine. The gaming machine 1 is a gaming machine which is played with a game medium such as coin, medal, gaming ball, token, and card memorizing the information about a game value awarded or to be awarded to a player. In the followings, it is described that a medal is used to play the game.

A front door 2 is provided at a front surface thereof with a panel display unit 2a having an approximate vertical surface, a liquid crystal display unit 2b and a fixed display unit 2c. In addition, three reels 3L, 3C, 3R having plural symbols drawn on peripheries thereof are rotatably mounted horizontally in a row at the rear of the front door 2. Each of the reels 3L, 3C, 3R is rotated at a constant speed (for example, 80 revolutions/min).

A base portion 4 having an approximate horizontal surface is provided below the panel display unit 2a, the liquid crystal display unit 2b and the fixed display unit 2c. A medal insertion slot 10 for inserting a medal is formed at a right side of the base portion 4. The inserted medal is credited or bet per a game. The base portion 4 is provided at a left side thereof with a 1-BET switch 11, a 2-BET switch 12 and a MAX-BET switch 13 for betting medals credited through a push operation.

When the 1-BET switch 11 is pushed one time, 1 piece of medals credited is bet per a game, when the 2-BET switch 12 is pushed one time, 2 pieces of medals credited is bet per a game, and when the MAX-BET switch 13 is pushed one time, the maximum medals which can be bet per a game are bet.

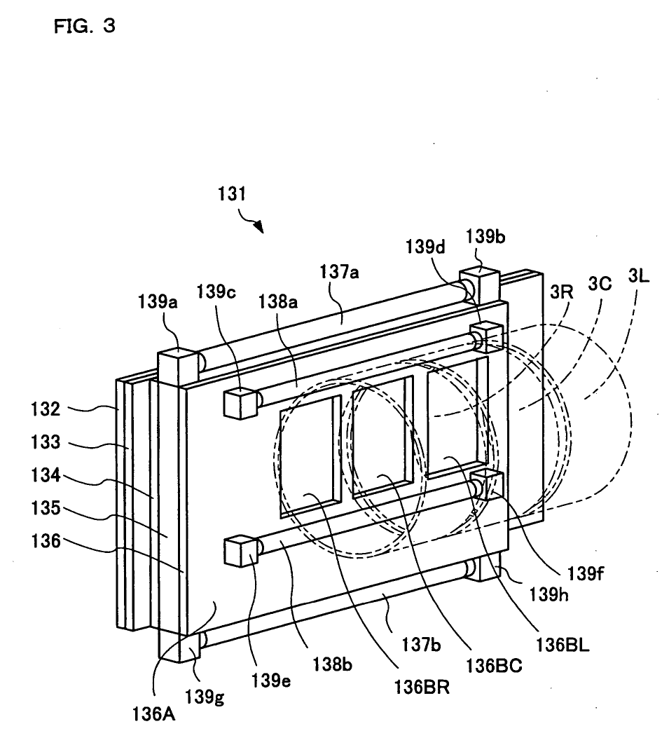

When the BET-switches 11 to 13 are pushed, a display line is activated (which will be specifically described later). Hereinafter, the operation of the BET-switches 11 to 13 and an operation of inserting a medal into the medal insertion slot 10 (operation of inserting a medal so as to play a game) are referred to as “bet operation.” An operating unit 17 is mounted above the BET switches 11 to 13. The operating unit 17 is manipulated so as to display the information such as game history on a liquid crystal display device 131 (see FIG. 3).

The base portion 4 is provided at the frontal left side with a C/P switch 14 for switching credits/payouts of medals, which are obtained by a player in the game, through the push operation of a button. When the C/P switch 14 is operated, the medals are paid out from a medal payout slot 15 at a frontal lower side and the paid out medals are stacked in a medal tray 5. Speakers 9L, 9R for producing an effect sound regarding the game effect are provided at the upper left and right sides of the medal tray 5.

A start lever 6 for rotating the reels to variably display the symbols in symbol display areas 21L, 21C, 21R by a manipulation of the player is mounted at the right side of the C/P switch 14 to be rotatable within a predetermined range of angles.

Three stop buttons 7L, 7C, 7R for stopping the rotation of the reels 3L, 3C, 3R are provided at the right side of the start lever 6 in the frontal center of the base portion 4. In addition, in one embodiment, a one game (unit game) is basically started by the operation of the start lever 6 and is over when all the reels 3L, 3C, 3R are stopped.

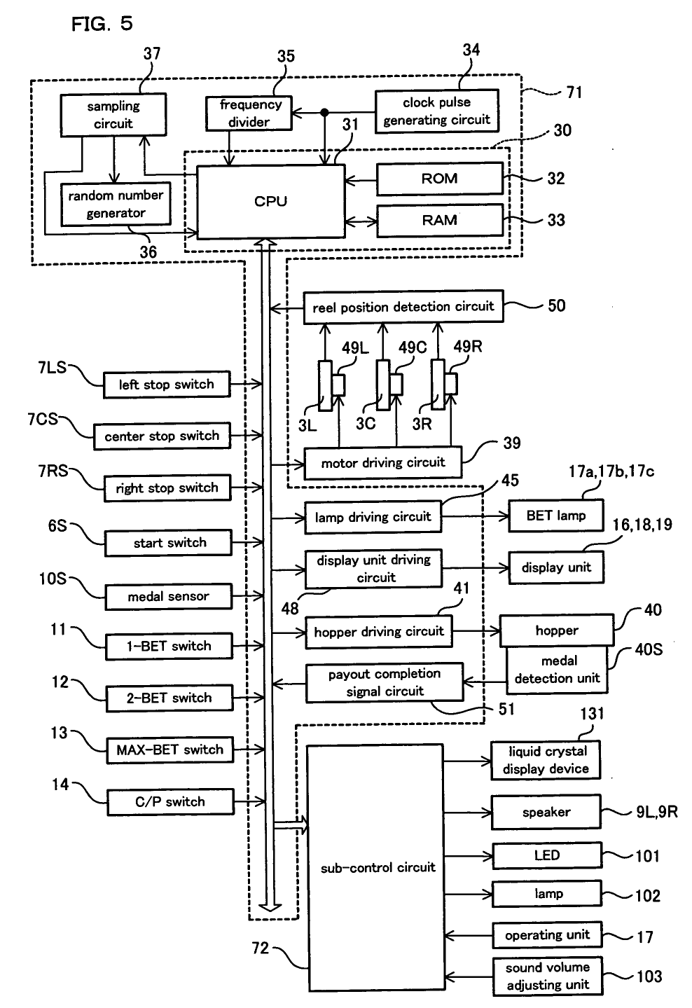

Herein, in one embodiment, a stop operation of the reel (i.e., operation of the stop button) carried out while all the reels are being rotated is referred to as a first stop operation, a stop operation which is carried out following the first stop operation is referred to as a second stop operation, and a stop operation which is carried out following the second stop operation is referred to as a third stop operation. In addition, stop switches 7LS, 7CS, 7RS are arranged at the rear of the stop buttons 7L, 7C, 7R, which will be described with reference to FIG. 5. The stop switches detect the operations (i.e., stop operations) of the corresponding stop buttons.

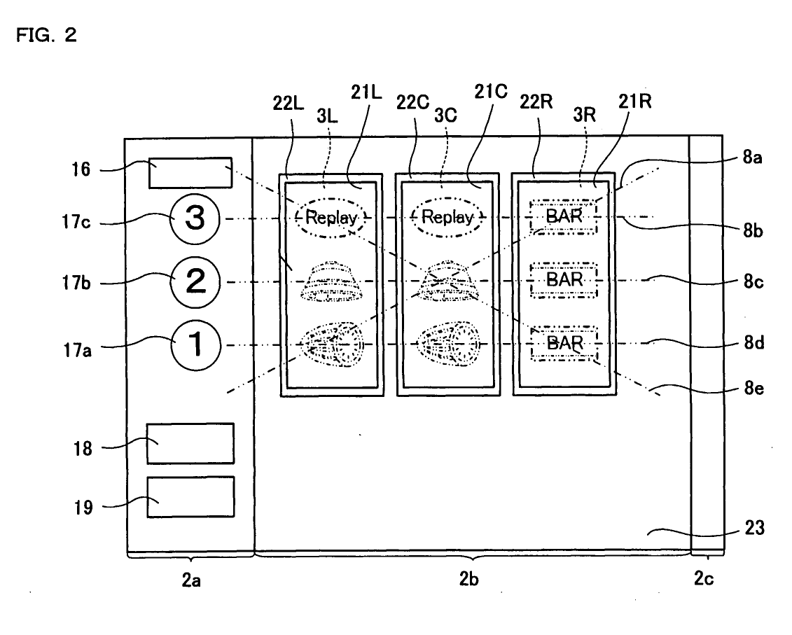

Hereinafter, the panel display unit 2a, the liquid crystal display unit 2b and the fixed display unit 2c are described with reference to FIG. 2.

The panel display unit 2a consists of a bonus game information display unit 16, BET lamps 17a to 17c, a payout display unit 18 and a credit display unit 19. The bonus game information display unit 16 consists of 7 segment LEDs and displays the game information under bonus game. The 1-BET lamp 17a, the 2-BET lamp 17b and the MAX-BET lamp 17c are turned on in accordance with the number of medals bet so as to play a one game (hereinafter, referred to as “bet number”).

The 1-BET lamp 17a is turned on when the bet number is 1. The 2-BET lamp 17b is turned on when the bet number is 2. The MAX-BET lamp 17c is turned on when the bet number is 3. The payout display unit 18 and the credit display unit 19 consist of 7 segment LEDs, respectively, and display the payout number of medals at the time when a winning is made and the number of medals credited.

The liquid crystal display unit 2b consists of symbol display areas 21L, 21C, 21R, frame display areas 22L, 22C, 22R and an effect display area 23. The display contents of the liquid crystal display unit 2b are adapted to vary in accordance with the rotation and stop modes of the reels 3L, 3C, 3R and an operation of the liquid crystal display device 131 which will be described later.

Each of the symbol display areas 21L, 21C, 21R is provided to correspond to each of the reels 3L, 3C, 3R and carries out the display of symbols arranged on the reels 3L, 3C, 3R or various displays for effects.

The symbol display areas 21L, 21C, 21R are provided with display lines, i.e., top line 8b, center line 8c and bottom line 8d which are horizontally directed and cross-up line 8a and cross-down line 8e which are diagonally directed. When the player pushes the BET-switches 11 to 13 or inserts medals into the medal insertion slot 10, these display lines are activated (hereinafter, activated display line is referred to as “activated line”). Each of the display lines 8a to 8e is activated when the bet number is 1 or more, irrespective of the bet number.

Herein, each of the symbol display areas 21L, 21C, 21R is provided with symbol stop positions at three (upper, central, lower) places in a longitudinal direction (vertical direction). When the variable display (moving display) of the symbols in the respective symbol display areas 21L, 21C, 21R is stopped, the symbols are stopped at each of the symbol stop positions provided to the respective symbol display areas 21L, 21C, 21R. Each of the display lines connects the symbol stop positions in the respective symbol display areas 21L, 21C, 21R.

The symbol display areas 21L, 21C, 21R are under transmissive state so that the player can see the symbols on the reels 3L, 3C, 3R, at least when the corresponding reels 3L, 3C, 3R are being rotated and when the corresponding stop buttons 7L, 7C, 7R can be pushed.

The frame display areas 22L, 22C, 22R are provided to surround each of the symbol display areas 21L, 21C, 21R, and display the frames of the symbol display areas 21L, 21C, 21R arranged on the front of the reels 3L, 3C, 3R.

The effect display area 23 is an area except the symbol display areas 21L, 21C, 21R and the frame display areas 22L, 22C, 22R of the liquid crystal display unit 2b. The fixed display unit 2c is an area in which a predetermined figure, picture and the like are drawn. It may be such structured that the figure, picture and the like drawn on the fixed display unit 2c and the image displayed on the effect display area 23 are correlated to display one still image or moving image.

FIG. 3 is a perspective view of schematically showing a structure of the liquid crystal display device 131. First, an inside structure of the reels 3L, 3C, 3R is described. In the reels 3L, 3C, 3R, LED receiving circuit boards are mounted at the rear of the three rows of symbols (i.e., 9 symbols) which are displayed in each of the symbol display areas 21L, 21C, 21R when the rotation of reels 3L, 3C, 3R are stopped. The LED receiving circuit boards include three LED receiving units (i.e., total nine), respectively, and plural LED lamps are mounted therein.

The LED lamps illuminate rear surfaces of reel sheets mounted along the peripheries of the reels 3L, 3C, 3R with a white light. More specifically, they illuminate areas corresponding to the symbol display areas 21L, 21C, 21R. The reel sheet is structured to have a transparent property and the lights emitted from the LED lamps pass through the front surface of the reel sheet.

In addition, the left reel 3L consists of a cylindrical frame structure formed by spacing two ring-shaped frames having a same shape at a predetermined interval (for example, reel width) and connecting them with plural connection members, and a transfer member for transferring a driving force of a stepping motor 49L mounted at a center of the frame structure to the ring-shaped frames. In addition, the reel sheet is mounted along the periphery of the left reel 3L.

The LED receiving circuit board arranged in the reel 3L includes three LED receiving units for receiving plural LED lamps. The LED receiving circuit board is mounted in such a way that the LED receiving units are respectively located at the rears of symbols (total 3 symbols) that a player can see through the symbol display area 21L. In addition, the center reel 3C and the right reel 3R have also the same structure as the left reel 3L and comprise the LED receiving circuit boards therein, respectively.

Next, the transmissive liquid crystal display device 131 is described. The liquid crystal display device 131 consists of a protecting glass 132, a display plate 133, a liquid crystal panel 134, a light guide plate 135, a reflecting film 136, fluorescent lamps 137a, 137b, 138a, 138b which are white light sources (for example, means for generating all wavelengths of lights, with a proportion that a specific color is unnoticeable), lamp holders 139a˜139h and a flexible board (not shown) consisting of a table carrier package having an IC for driving the liquid crystal panel mounted thereon and connected to a terminal unit of the liquid crystal panel 134.

The liquid crystal display device 131 is mounted at the front (i.e., in front of a display surface) of the display areas of the reels 3L, 3C, 3R, viewing from the front face. In addition, the reels 3L, 3C, 3R and the liquid crystal display device 131 are separately (for example, at an interval) mounted.

The protecting glass 132 and the display plate 133 are made of transmissive members. The protecting glass 132 is provided to protect the liquid crystal panel 134. In the display plate 133, a figure, a picture and the like are drawn on areas corresponding to the panel display unit 2a and the fixed display unit 2c (see FIG. 2).

Herein, in FIG. 3, it is not shown an electric circuit provided to operate the various display units (the bonus game information display unit 16, the payout display unit 18, the credit display unit 19) and the BET lamps 17a to 17c arranged at the rear of the area of the display plate 133 corresponding to the panel display unit 2a.

In the liquid crystal panel 134, liquid crystals are sealingly injected in a gap between a transparent board such as glass plate having a thin film transistor layer formed thereon and a transparent board opposite to the board. A display mode of the liquid crystal panel 134 is set as a normally white. The normally white is such a structure that it becomes a white display under state that the liquid crystal is not driven (i.e., state that a voltage is not applied to the liquid crystal panel 134). In other words, the light travels to the display surface, so that the transmitted light is visible from the outside.

Accordingly, by adopting the liquid crystal panel 134 structured with the normally white, even when there occurs a state at which the liquid crystal cannot be driven, it is possible to see the symbols arranged on the reels 3L, 3C, 3R through the symbol display areas 21L,21C, 21R and to continuously play the game. In other words, even when there occurs such state that the liquid crystal cannot be driven, it is possible to play the game in relation to the rotation and stop of the reels 3L, 3C, 3R.

The light guide plate 135 is provided at the rear of the liquid crystal panel 54 so as to guide the light from the fluorescent lamps 137a, 137b into the liquid crystal panel 134 (i.e., to illuminate the liquid crystal panel 134) and consists of a transmissive member (i.e., a member having a light guide function) such as acryl-based resin having about 2 cm thickness, for example.

For the reflecting film 136, it is possible to use a material having silver deposition film formed on a white polyester film or aluminum thin film, for example. The reflecting film reflects the light, which is introduced into the light guide plate 135, toward the front. Thereby, the liquid crystal panel 134 is illuminated. The reflecting film 136 consists of a reflecting area 136A and non-reflecting areas (i.e., transmissive areas) 136BL, 136BC, 136BR. The non-reflecting areas 136BL, 136BC, 136BR are formed as light-transmitting units which are made of transparent materials, so that they transmit the incident light without reflecting it.

In addition, the non-reflecting areas 136BL, 136BC, 136BR are provided at front positions of the symbols which are displayed when the rotation of reels 3L, 3C, 3R is stopped. In the mean time, sizes and positions of the non-reflecting areas 136BL, 136BC, 136BR are structured to be matched to the symbol display areas 21L, 21C, 21R (see FIG. 2). Further, in the reflecting film 136, an area except the non-reflecting areas 136BL, 136BC, 136BR is the reflecting area 136A which reflects the light introduced to the light guide plate 135 toward the front.

The fluorescent lamps 137a, 137b are arranged along upper and lower ends of the light guide plate 135 and supported at their both ends by the lamp holders 139a, 139b, 139g, 139h. The fluorescent lamps 137a, 137b generate the light to be introduced into the light guide plate 135.

The fluorescent lamps 138a, 138b are arranged at upper and lower parts of the rear of the reflecting film 136. The lights generated from the fluorescent lamps 138a, 138b are reflected at the surfaces of the reels 3L, 3C, 3R and then incident on the non-reflecting area 136BL, 136BC, 136BR. The incident lights pass through the non-reflecting area 136BL, 136BC, 136BR to illuminate the liquid crystal panel 134.

Hereinafter, functions of the LED lamps and the fluorescent lamps 137a, 137b, 138a, 138b are described.

First, it is described a function of each lamp when the liquid crystals of the symbol display areas 21L, 21C, 21R are not driven (i.e., voltage is not applied to places corresponding to the symbol display areas 21L, 21C, 21R of the liquid crystal panel 134).

Some of the lights emitted from the fluorescent lamps 138a, 138b are reflected by the reel sheet. In addition, some of the lights emitted from the LED lamps mounted at the LED receiving circuit board transmit the reel sheet. Since these lights transmit the non-reflecting areas 136BL, 136BC, 136BR, and the light guide plate 135 and the liquid crystal panel 135 which constitute the liquid crystal display device 131, the player can see the symbols arranged on the reels.

In addition, the lights, which are emitted from the fluorescent lamps 137a, 137b and introduced toward the light guide plate 135, pass through the liquid crystal panel 134 and are incident to the player's eyes. In other words, the areas of the liquid crystal panel 134 corresponding to the frame display areas 22L, 22C, 22R and the effect display area 23 are illuminated by the fluorescent lamps 137a, 137b.

Next, it is described a function of each lamp when the liquid crystals of the symbol display areas 21L, 21C, 21R are driven (i.e., voltage is applied to the places corresponding to the symbol display areas 21L, 21C, 21R of the liquid crystal panel 134).

Some of the lights emitted from the fluorescent lamps 138a, 138b are reflected by the reel sheet. In addition, some of the lights emitted from the LED lamps transmit the reel sheet. Since some of these lights are reflected, absorbed or transmitted in the liquid crystal driven area of the areas of the liquid crystal panel 134, the player can see an effect image and the like displayed in the symbol display areas 21L, 21C, 21R.

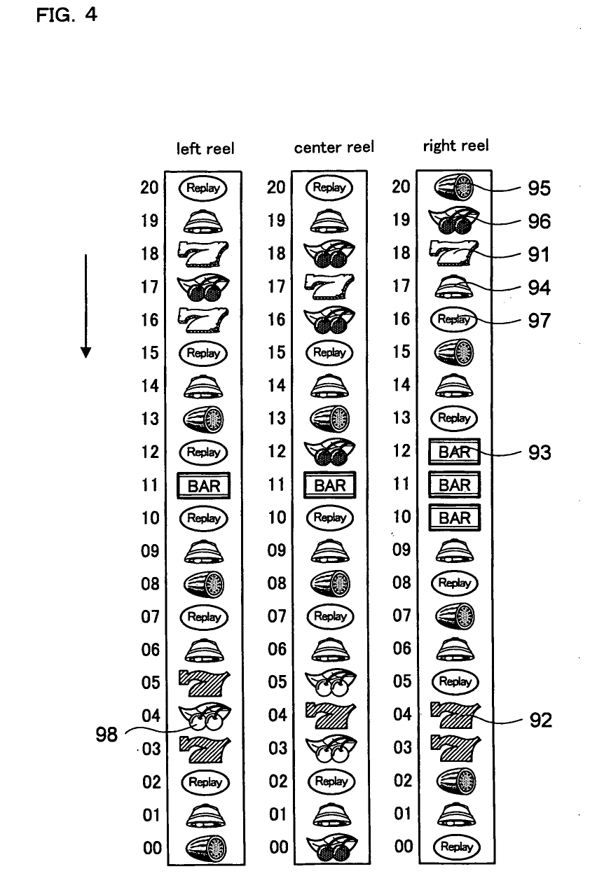

FIG. 4 shows symbol rows displayed on the reels 3L, 3C, 3R, in each of which 21 symbols are arranged. Each of the symbols is given with code numbers of “00”˜“20,” and stored (memorized) as a data table in a ROM 32 (see FIG. 5) which will be described later. Each of the reels 3L, 3C, 3R is arranged with the symbol row consisting of “Red 7 (symbol 91),” “Blue 7 (symbol 92),” “BAR (symbol 93),” “Bell (symbol 94),” “Watermelon (symbol (95),” “Red Cherry (symbol 96),” “Replay (symbol 97)” and “Blue Cherry (symbol 98)”. Each of the reels 3L, 3C, 3R is rotated so that the symbol rows are moved in an arrow direction of FIG. 4.

Herein, in one embodiment, BB1, BB2 and Middle Bonus (hereinafter, referred to as “MB”), Red Cherry, Bell, Watermelon, RT1, RT2, RT3, complex combination and Replay are provided as a combination. In addition, BB1, BB2 and MB are collectively referred to as “bonus.” BB1 and BB2 are collectively referred to as “BB.” RT1, RT2 and RT3 are collectively referred to as “RT.” In addition, BB is a single bonus-continuous operation device relating to a first type special single bonus. RT is a combination providing an occasion that a RT section is operated.

The combination (combination data) is the control information in which a payout to be awarded to the player is matched to a symbol combination in advance, and is used for the stop control of the reels 3L, 3C, 3R, the switch (shift) of the gaming state, the award of the game value and the like. In the complex combination, plural combinations of a payout to be awarded to the player and a symbol combination are matched (i.e., it is a set of plural combinations). A symbol combination to be displayed (payout to be awarded to a player) is determined in accordance with an operation timing of the stop buttons 7L, 7C, 7R by the player.

In addition, in one embodiment, the gaming state includes a normal gaming state, a RB gaming state and a challenge bonus gaming state (hereinafter, abbreviated to “CB gaming state”). Basically, the gaming state can be identified by a kind of an internal lottery table used to determine an internal winning combination and a mode of the stop control of the reel (so-called “the maximum number of sliding symbols”). Specifically, the gaming state can be identified by a kind of a combination which may be internally won, a probability that an internal winning will be made, the maximum number of sliding symbols and the like.

The normal gaming state consists of a base section having no internal carryover combination, a Replay time section (hereinafter, abbreviated to “RT section”) in which it is high a probability that an internal winning of Replay will be made, and a carryover section having an internal carryover combination. In the carryover section, there is no case where an internal winning of the bonus is made. In the base section and the RT section, an internal winning of the bonus may be made. In the RT section, it is higher a probability that an internal winning of Replay will be made, as compared to the base section and the carryover section.

Accordingly, the base section, the RT section and the carryover section are gaming states different from each other. The internal carryover combination is a combination which permits a corresponding symbol combination to be arranged along the activated line over one or more games (i.e., it is a combination permitted depending on the internal winning combination). The internal carryover combination is included in the internal winning combination. The game section, except the RT section, in the normal gaming state is referred to as “non-RT section.”

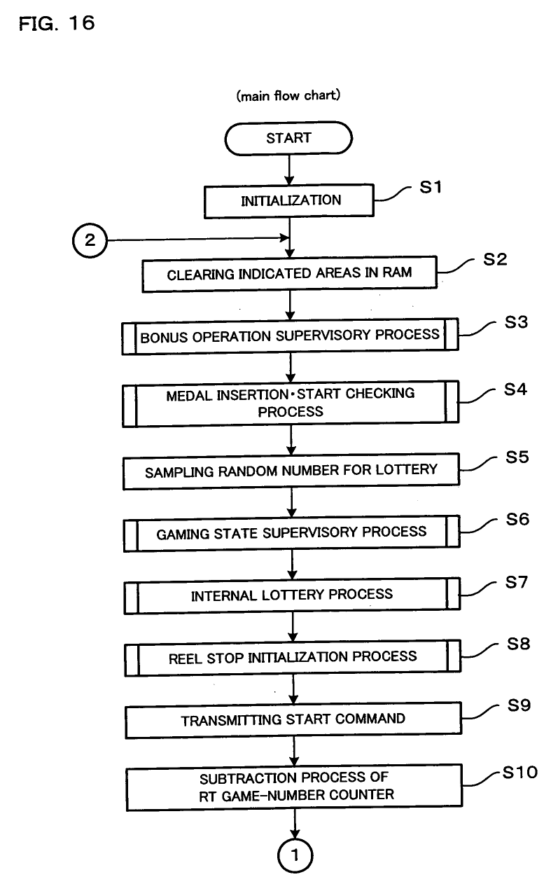

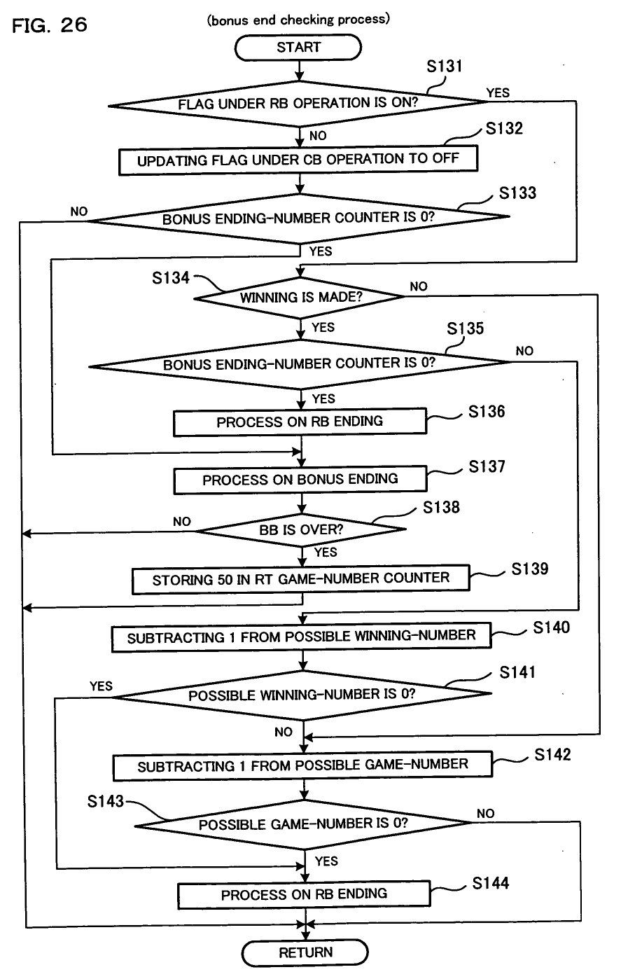

It is possible to determine whether or not it is under RT section, depending on whether or not a RT game-number counter is 1 or more. When a symbol combination corresponding to RT is displayed along the activated line, one of 50, 100 and 200 is set in the RT game-number counter, correspondingly to RT established (see a RT operation checking process). In addition, 50 is set in the RT game-number counter at the time when a normal gaming state is started after BB is established (see a step S139 in FIG. 26). The value of the RT game-number counter is subtracted by 1 in one game (see a step S10 in FIG. 16). In addition, when an internal winning of the bonus is made, the value of the RT game-number counter is updated (cleared) to 0.

It is possible to determine whether or not it is under carryover section, depending on whether or not there is the internal carryover combination. In case that there is no internal carryover combination and the value of the RT game-number counter is 0, it is under base section.

The RB gaming state is a gaming state consisting of a game in which “the first type special single bonus” operates. The RB gaming state can be identified, depending on whether a flag under RB operation is ON or OFF. The flag under RB operation is the information for identifying whether or not a gaming state is the RB gaming state. When a flag under BB operation is ON, the flag under RB operation is updated to ON.

When a possible game-number is 0, when a possible winning-number is 0 or when the flag under BB operation is updated to OFF, the flag under RB operation is updated to OFF. The possible game-number is the number of unit games which can be carried out in the RB gaming state. The possible winning-number is the number of cases where a winning can be made in the RB gaming state.

The flag under BB operation is the information for identifying whether or not it is under advantageous state which occurs when BB is made. With regard to a unit game value (for example, 1 medal bet per a game) used to play a game in the advantageous state, an expected value of a game value to be awarded to a player is relatively higher than in the normal gaming state (i.e., the extent of advantage is relatively higher). When BB is made, the flag under BB operation is updated to ON. When the number of medals paid out exceeds a possible payout-number (i.e., when bonus ending-number counter becomes 0), the flag under BB operation is updated to OFF. The possible payout-number is the number of medals which can be paid out in a game from after the flag under BB operation is updated to ON until the flag under BB operation is updated to OFF. When BB is made, 350 is set as an initial value of the bonus ending-number counter.

Herein, it is described a relationship of the flag under RB operation and the flag under BB operation from after the flag under BB operation is updated to ON until it is updated to OFF. When BB is made, the flag under BB operation is updated to ON. As the flag under BB operation is updated to ON, the flag under RB operation is updated to ON. Then, when the possible game-number becomes 0 or when the possible winning-number becomes 0, the flag under RB operation is updated to OFF. If the flag under BB operation is ON the flag under RB operation is again updated to ON.

If the condition that the flag under BB operation is updated to OFF is satisfied, the flag under BB operation is updated to OFF. At this time, with the flag under BB operation being updated to OFF, the flag under RB operation is updated to OFF. Accordingly, when the flag under BB operation is ON, the flag under RB operation is updated to ON. In other words, after BB is made, the RB gaming state is maintained until the flag under BB operation is updated to OFF.

The CB gaming state is a gaming state structured by a game in which “a second type special single bonus” operates. In the CB gaming state, the left reel 3L is under no control state (the maximum number of sliding symbols is 1) and the maximum number of sliding symbols of the other reels is 4. In addition, in the gaming state except the CB gaming state, the maximum number of sliding symbols is 4. The number of sliding symbols is a moving amount of a symbol after the corresponding stop button is pushed.

The CB gaming state can be identified depending on whether a flag under CB operation is ON or OFF. The flag under CB operation is the information for identifying whether or not a gaming state is the CB gaming state. When a flag under MB operation is ON, the flag under CB operation is updated to ON. When one game is over, the flag under CB operation is updated to OFF (see a step S132 in FIG. 26).

The flag under MB operation is the information for identifying whether or not it is under advantageous state which occurs when MB is made. With regard to a unit game value used to play a game (for example, 1 medal bet per a game) in the advantageous state, an expected value of a game value to be awarded to a player is relatively higher than in the normal gaming state (i.e., the extent of advantage is relatively higher). When MB is made, the flag under MB operation is updated to ON. MB is a single bonus-continuous operation device relating to a second type special single bonus. When the number of medals paid out exceeds the possible payout-number (i.e., when the bonus ending-number counter becomes 0), the flag under MB operation is updated to OFF. The possible payout-number is the number of medals which can be paid out in a game from after the flag under MB operation is updated to ON until the flag under MB operation is updated to OFF. When MB is made, 250 is set as an initial value of the bonus ending-number counter.

Herein, it is described a relationship of the flag under CB operation and the flag under MB operation from after the flag under MB operation is updated to ON until it is updated to OFF. When MB is made, the flag under MB operation is updated to ON. In case that the flag under MB operation is ON, the flag under CB operation is updated to ON. Then, when a game is over, the flag under CB operation is updated to OFF. If the flag under MB operation is ON at the time when a game is started, the flag under CB operation is again updated to ON.

If the condition that the flag under MB operation is updated to OFF is satisfied, the flag under MB operation is updated to OFF. At this time, with the flag under MB operation being updated to OFF, it is maintained the state that the flag under CB operation is updated to OFF. Accordingly, when the flag under MB operation is ON, the flag under CB operation is updated to ON. In other words, after MB is made, the CB gaming state is maintained until the flag under MB operation is updated to OFF.

FIG. 5 shows a circuit structure comprising a main control circuit 71 controlling a game process operation of the gaming machine 1, a peripheral device (i.e., actuator) electrically connected to the main control circuit 71, and a sub-control circuit 72 controlling the liquid crystal display device 131, the speakers 9L, 9R, the LED 100a and the lamp 100b on the basis of control commands transmitted from the main control circuit 71. In addition, a sound volume of the speakers 9L, 9R can be adjusted by a manipulation of a sound volume adjusting unit 103.

The main control circuit 71 comprises a micro computer 30 arranged on a circuit board as a main constituting element and is further provided with a circuit for sampling random numbers. The micro computer 30 includes a CPU 31 for carrying out the control operations in accordance with preset programs (see FIGS. 16 to 29), and a ROM 32 and a RAM 33 which are memory means.

To the CPU 31 is connected a clock pulse generating circuit 34 and a frequency divider 35 for generating a reference clock pulse, and a random number generator 36 and a sampling circuit 37 for generating a random number to be sampled. In the mean time, as means for the random number sampling, it may be structured such that the random number sampling is carried out in the micro computer 30, i.e., on an operating program of the CPU 31. In this case, the random number generator 36 and the sampling circuit 37 may be omitted. Alternatively, they may be also held for a backup of the random number sampling operation.

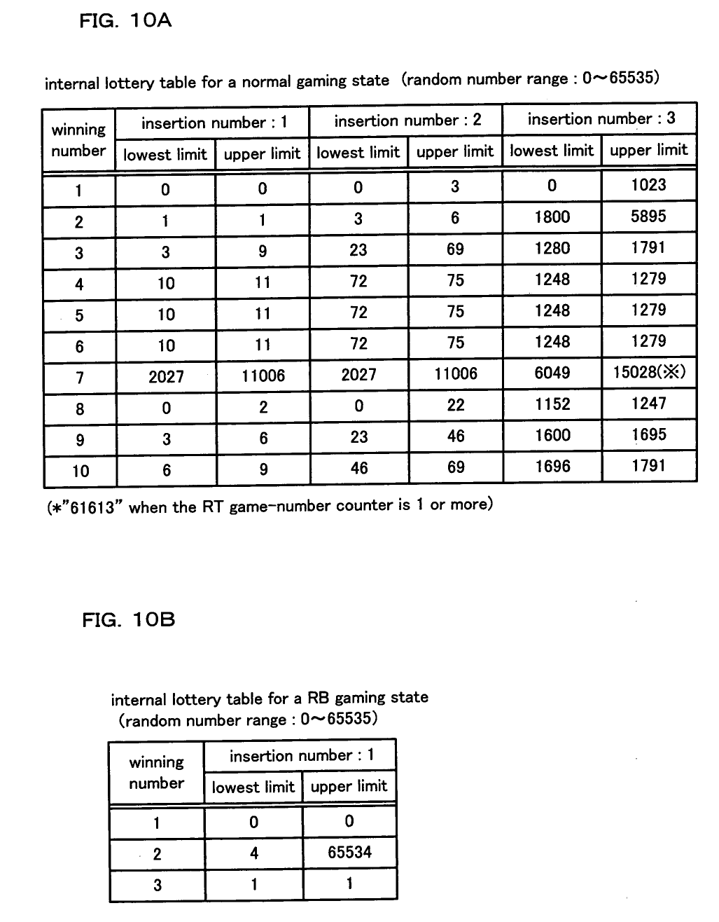

The ROM 32 of the micro computer 30 stores an internal lottery table (see FIG. 10) used to determine the random number sampling which is carried out whenever the start lever 6 is operated (the start operation is carried out), a stop table group for determining a stop mode of the reel in accordance with the operation of the stop button, and the like. In addition, various control commands for being transmitted to the sub-control circuit 72 and the like are stored therein. In the mean time, a command, information and the like are not transmitted from the sub-control circuit 72 to the main control circuit 71. In other words, it is carried out a one-way communication from the main control circuit 71 to the sub-control circuit 72. Various information is stored in the RAM 33 which is provided with various storage areas. The RAM 33 stores an internal winning combination, an internal carryover combination, the information about a current gaming state, and the like.

In the circuit shown in FIG. 5, main actuators controlled by control signals from the micro computer 30 include display units such as BET lamps (1-BET lamp 17a, 2-BET lamp 17b, MAX-BET lamp 17c), bonus game information display unit 16, payout display unit 18, credit display unit 19 and the like, a hopper 40 (including a driving unit for payout) receiving a medal and paying out the predetermined number of medals by a command of a hopper driving circuit 41, and stepping motors 49L, 49C, 49R for rotating the reels 3L, 3C, 3R.

In addition, to the outputs of the CPU 31 are connected a motor driving circuit 39 for controlling the stepping motors 49L, 49C, 49R, the hopper driving circuit 41 for controlling the hopper 40, a lamp driving circuit 45 for controlling the BET lamps 17a, 17b, 17c and a display unit driving circuit 48 for controlling the display units, such as bonus game information display unit 16, payout display unit 18, credit display unit 19 and the like. These driving circuits receive the control signals outputted from the CPU 31 to control the operations of the actuators, respectively.

In addition, as means for generating an input signal required so that the micro computer 30 generates a control signal, there are provided the start switch 6S, the stop switches 7LS, 7CS, 7RS, the 1-BET switch 11, the 2-BET switch 12, the MAX-BET switch 13, the C/P switch 14, a medal sensor 10S, a reel position detection circuit 50 and a payout completion signal circuit 51.

The start switch 6S detects a manipulation of the start lever 6 and outputs a game start command signal (signal for commanding a game start). The medal sensor 10S detects a medal inserted into the medal insertion slot 10S. The stop switches 7LS, 7CS, 7RS generate a stop command signal (signal for commanding a stop of the symbol variation) in accordance with the operations of the corresponding stop buttons 7L, 7C, 7R. The reel position detection circuit 50 receives a pulse signal from reel rotating sensors and supplies a signal for detecting a position of the respective reels 3L, 3C, 3R to the CPU 31. The payout completion signal circuit 51 generates a signal for detecting a payout completion of the medal when a value counted by a medal detection unit 40S (i.e., the number of medals paid out from the hopper 40) reaches the data of a predetermined value.

In the circuit of FIG. 5, the random number generator 36 generates random numbers within a predetermined range, and the sampling circuit 37 samples one random number at an appropriate timing after the start lever 6 is manipulated. The random number value sampled is used to determine an internal winning combination and the like on the basis of the internal lottery table (see FIG. 10) stored in the ROM 32, for example. The internal winning combination (internal winning combination data) is the information for identifying a mode of the stop control or identifying a combination which can be a display combination (a combination which can be allowed as a display combination). It can be said that an internal winning combination is indirectly matched to a corresponding symbol combination and a payout to be awarded to the player, through a mode of stop control corresponding to the internal winning combination.

After the reels 3L, 3C, 3R start to rotate, it is counted the number of driving pulses supplied to the respective stepping motors 49L, 49C, 49R and the counted value is written in a predetermined area of the RAM 33. In the mean time, a reset pulse is obtained from the reels 3L, 3C, 3R every one revolution and then inputted to the CPU 31 through the reel position detection circuit 50. The counted value of the driving pulses stored in the RAM 33 is cleared to “0” by the reset pulse obtained. Thereby, the counted value corresponding to a rotating position within a range of one revolution is stored in the RAM 33, with regard to each of the reels 3L, 3C, 3R.

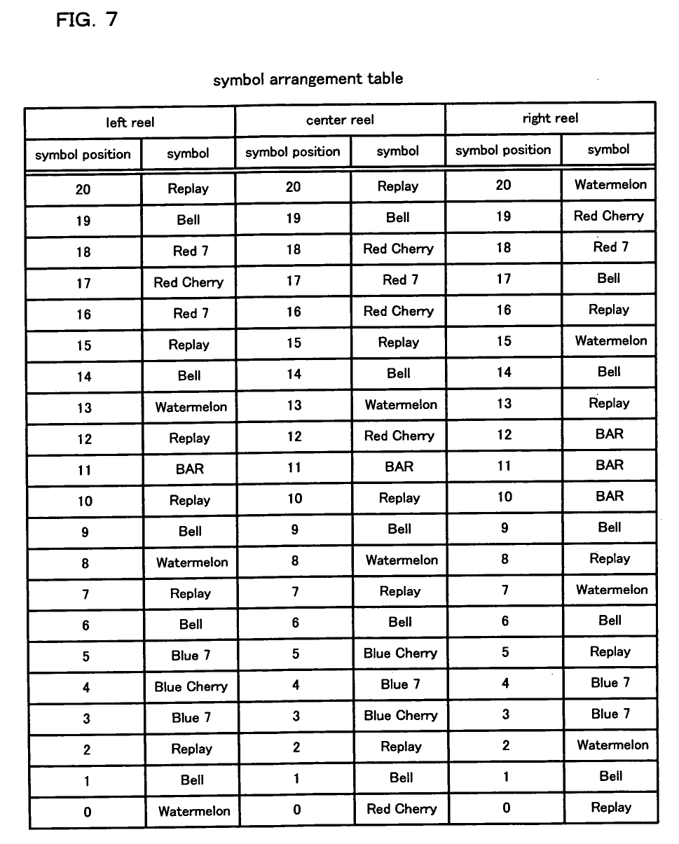

In order to match the rotating positions of the reels 3L, 3C, 3R to the symbols arranged on the peripheries of the reels, a symbol arrangement table (see FIG. 7) is stored in the ROM 32. In this symbol table, on the basis of the rotating positions generated by the reset pulse, code numbers sequentially given every rotation pitch of the respective reels 3L, 3C, 3R are matched to symbol codes representing symbols provided to correspond to each of the code numbers.

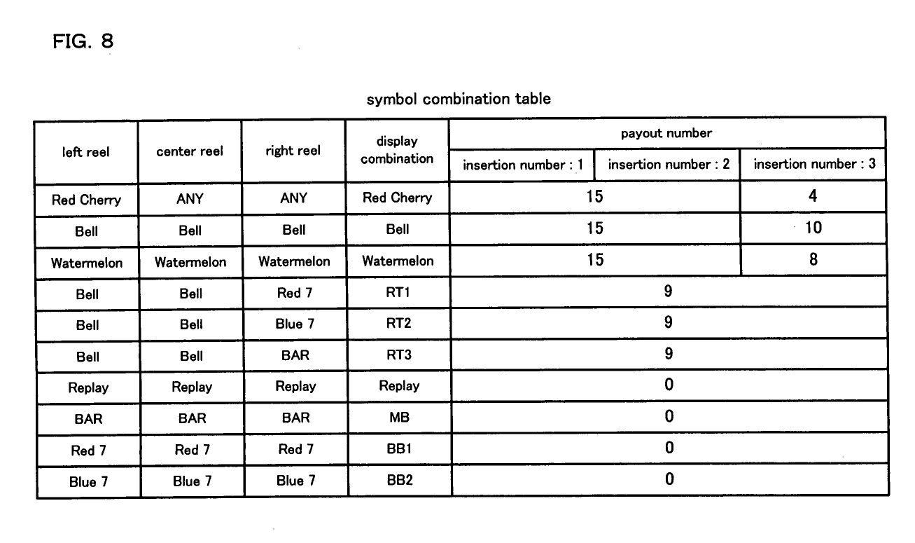

In addition, a symbol combination table (see FIG. 8) is stored in the ROM 32. In the symbol combination table, it is matched a combination of symbols (a combination of symbols corresponding to a display combination) in which a combination is made (winning), the payout number of medals corresponding to a display combination and a winning determining code (establishment determining code) (not shown) representing that the winning is made. The symbol combination table is referred to when it is carried out the stop control of the left reels 3L, the center reel 3C and the right reel 3R, when it is carried out a winning confirmation (confirmation of a display combination) after all the reels 3L, 3C, 3R are stopped and when it is carried out a determination of the payout number. The display combination (display combination data) is a combination (establishment combination) corresponding to a symbol combination arranged along the activated line. A payout corresponding to the display combination is awarded to the player.

In case that an internal winning combination is determined by a lottery process (for example, internal lottery process) based on the random number sampling, the CPU 31 transmits a signal for performing the control for stopping the rotations of the reels 3L, 3C, 3R to the motor driving circuit 39, on the basis of the signals transmitted from the stop switches 7LS, 7CS, 7RS at the timing at which the player operates the stop buttons 7C, 7L, 7R and the determined stop table.

When it is made a stop mode (winning mode) representing a winning of a determined combination, the CPU 31 supplies a payout command signal to the hopper driving circuit 41 to pay out the predetermined number of medals from the hopper 40. At this time, the medal detection unit 40S counts the number of medals paid out from the hopper 40, and the medal payout completion signal is inputted to the CPU 31 when the counted value reaches a predetermined value. Thereby, the CPU 31 stops the driving of the hopper 40 through the hopper driving circuit 41 and ends the medal payout process.

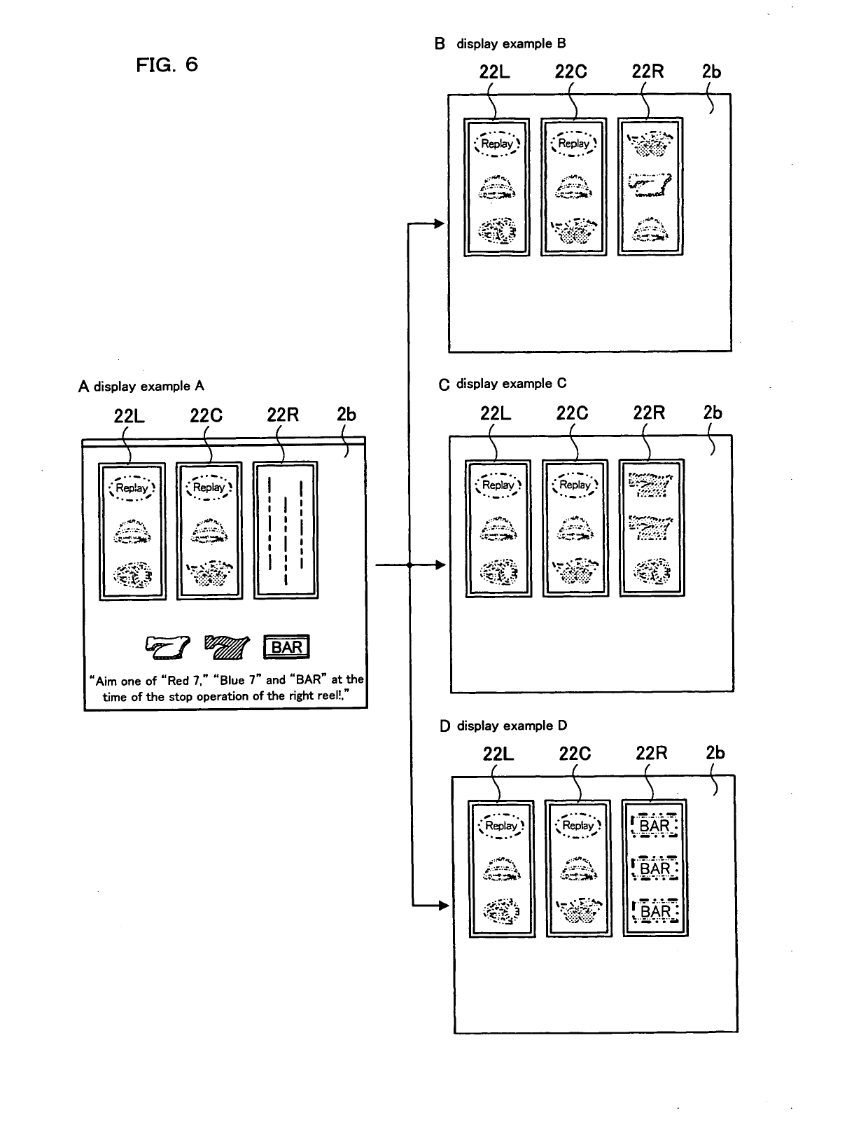

In the followings, it is described display examples A to D of the liquid crystal display unit 2b, with reference to FIG. 6.

A display example A shown in FIG. 6A is one mode of the liquid crystal display unit 2b at the time of the stop operation of the right reel 3R, when RT1, RT2 and RT3 are determined as an internal winning combination by the lottery of one time. In the liquid crystal display unit 2b, it is displayed “Aim one of “Red 7,” “Blue 7” and “BAR” at the time of the stop operation of the right reel!,” as a notification of an internal winning combination. In addition, the notification is carried out when the start lever 6 is manipulated and RT1, RT2 and RT3 are determined as an internal winning combination by the lottery of one time, and is over when the third stop operation is carried out.

A display example B shown in FIG. 6B is one example of the stop mode of the stopped symbols caused by the third stop operation which is carried out in the display example A. Specifically, “Bell-Bell-Red 7” are displayed along the activated line in the symbol display areas 21L, 21C, 21R of the liquid crystal display unit 2b. A display example C shown in FIG. 6C is one example of the stop mode of the stopped symbols caused by the third stop operation which is carried out in the display example A. Specifically, “Bell-Bell-Blue 7” are displayed along the activated line in the symbol display areas 21L, 21C, 21R of the liquid crystal display unit 2b. A display example D shown in FIG. 6D is one example of the stop mode of the stopped symbols caused by the third stop operation which is carried out in the display example A. Specifically, “Bell-Bell-BAR” are displayed along the activated line in the symbol display areas 21L, 21C, 21R of the liquid crystal display unit 2b.

Herein, the internal winning combination is determined on the basis of the internal lottery table (see FIG. 10) by an internal lottery process which will be described later. In the internal lottery table, the lowest and upper limits corresponding to RT1, RT2 and RT3 are constituted to be same. In other words, in case that a random number value sampled (i.e., random number value sampled in a process of a step S5 in FIG. 16) is within a numerical range of the lowest and upper limits, RT1, RT2 and RT3 are determined as an internal winning combination by the lottery of one time.

In addition, as described in below with regard to FIG. 8, when “Bell-Bell-Red 7” are displayed along the activated line, RT1 becomes a display combination, when “Bell-Bell-Blue 7” are displayed along the activated line, RT2 becomes a display combination, and when “Bell-Bell-BAR” are displayed along the activated line, RT3 becomes a display combination. In the arrangement of the symbols in the left reel 3L and the center reel 3R, it is such structured that an interval between “Bell” and “Bell” is within 4 symbols. Accordingly, since the maximum number of sliding symbols is 4, it is possible to stop “Bell” on the activated line, irrespective of the timing of the stop operation. Thereby, when RT1, RT2 and RT3 are determined as an internal winning combination, “Bell” is stopped at the central stop positions of the left reel 3L and the center reel 3R, without fail.

Accordingly, in case that RT1, RT2 and RT3 are determined as an internal winning combination by the lottery of one time and “Bell” is displayed along the activated line (see FIG. 6A) after the stop operation is carried out through the left stop button 7L corresponding to the left reel 3L and the center stop button 7C corresponding to the center reel 3C, it is permitted that one of “Red 7,” “Blue 7” and “BAR” is stopped at the central symbol stop position (i.e., activated position) of the right reel 3R. In addition, in case that Bell is determined as an internal winning combination and “Bell” is displayed along the activated line after the stop operation is carried out through the left stop button 7L corresponding to the left reel 3L and the center stop button 7C corresponding to the center reel 3C, it is not permitted that one of “Red 7,” “Blue 7” and “BAR” is stopped at the central symbol stop position of the right reel 3R.

In addition, since one “Red 7” is arranged, two “Blue 7's” are successively arranged and three “BARs” are successively arranged in the right reel 3R (see FIG. 4), it is easy to carry out the stop operation, so-called push observation operation so that desired symbols are stopped at the central symbol position of the right reel 3R in order of “Red 7,” “Blue 7” and “BAR.” In addition, it is such set that the number of sliding symbols of “Red 7” is 1, the number of sliding symbols of “Blue 7” is 2 and the number of sliding symbols of “BAR” is 3. In other words, it is easy to carry out the push observation operation so that desired symbols are stopped at the central symbol position of the right reel 3R in order of “Red 7,” “Blue 7” and “BAR.” Like this, the degree of difficulty of the observation push operation is constituted to be different depending on the desired symbols, through the symbol arrangement of the right reel 3R and the number of sliding symbols set to correspond to the symbol.

In the mean time, in case that “Bell-Bell-Red 7” are displayed along the activated line by the observation push operation for “Red 7” and RT1 becomes a display combination (see FIG. 6B), it is awarded a payout that the RT section is continued over 200 games. In case that “Bell-Bell-Blue 7” are displayed along the activated line by the observation push operation for “Blue 7” and RT2 becomes a display combination (see FIG. 6C), it is awarded a payout that the RT section is continued over 100 games. In case that “Bell-Bell-BAR” are displayed along the activated line by the observation push operation for “BAR” and RT3 becomes a display combination (see FIG. 6D), it is awarded a payout that the RT section is continued over 50 games.

Like this, when it is notified that RT1, RT2 and RT3 are determined as an internal winning combination, it is allowed that one of “Red 7,” “Blue 7” and “BAR” is stopped at the central symbol stop position of the center reel 3R. However, since the degrees of difficulty of the observation push operation are different and the payouts resulting from the degrees of difficulty of the observation push operation are different, the player can carry out the stop operation with the aiming of any one of “Red 7,” “Blue 7” and “BAR,” considering the player's own ability.

Accordingly, since the number of times (i.e., the number of games in which the RT section is continued) is different, which is caused by the player's decision and stop operation, the player takes a positive attitude to the game, so that it is possible to exclude a source causing the player to lose an interest in a game and a source causing a game to be monotonous.

In the followings, it is described a symbol arrangement table with reference to FIG. 7.

The symbol arrangement table includes the information about the symbols arranged on the reel peripheries corresponding to the symbol positions (code numbers) of the reels 3L, 3C, 3R. Based on the symbol arrangement table and a symbol combination table which will be described later, it is possible to perceive the combinations of symbols arranged along the respective activated lines.

In the followings, it is described a symbol combination table with reference to FIG. 8.

The symbol combination table includes the information about a display combination corresponding to a combination of symbols stopped at each of the three symbol stop positions connected by the one activated line and the information about the payout number for each of the insertion numbers (bet numbers) corresponding to the display combination. The symbol combination table is referred to when the payout number is determined in accordance with the combination of symbols displayed along the activated line after all the reels 3L, 3C, 3R are stopped.

When a winning number, which will be described later, is 1 (Red Cherry), Red Cherry may be a display combination. Red Cherry comprises a corner cherry and an inner cherry. One of the corner cherry and the inner cherry becomes a display combination, depending on the operation timing of the left stop button 7L. When a so-called “reckless push operation” for “Red Cherry” is carried out at the center line 8c, the inner cherry becomes a display combination.

When “Red Cherry (corner)-Any-Any” are arranged along the activated line, the corner cherry becomes a display combination. At this time, when the insertion number is 1 or 2, 15 medals are paid out, and when the insertion number is 3, 8 medals are paid out. “Red Cherry (corner)” represents “Red Cherry” which is stopped at the upper or lower position of the left symbol display area 21L. “Any” represents any symbol.

When “Red Cherry (inner)-Any-Any” are arranged along the activated line, the inner cherry becomes a display combination. At this time, when the insertion number is 1 or 2, 15 medals are paid out, and when the insertion number is 3, 4 medals are paid out. “Red Cherry (inner)” represents “Red Cherry” which is stopped at the central position of the left symbol display area 21L.

When “Bell-Bell-Bell” are arranged along the activated line, Bell becomes a display combination. At this time, when the insertion number is 1 or 2, 15 medals are paid out, and when the insertion number is 3, 10 medals are paid out. When “Watermelon-Watermelon-Watermelon” are arranged along the activated line, Watermelon becomes a display combination. At this time, when the insertion number is 1 or 2, 15 medals are paid out, and when the insertion number is 3, 8 medals are paid out.

When “Bell-Bell-Red 7” are arranged along the activated line, RT1 becomes a display combination, 9 medals are paid out and 200 is set in the RT game-number counter, so that the gaming state is shifted to the RT section. When “Bell-Bell-Blue 7” are arranged along the activated line, RT2 becomes a display combination, 9 medals are paid out and 100 is set in the RT game-number counter, so that the gaming state is shifted to the RT section. When “Bell-Bell-BAR” are arranged along the activated line, RT3 becomes a display combination, 9 medals are paid out and 50 is set in the RT game-number counter, so that the gaming state is shifted to the RT section. When “Replay-Replay-Replay” are arranged along the activated line, Replay becomes a display combination and medals are automatically inserted.

When “BAR-BAR-BAR” are arranged along the activated line, MB becomes a display combination and the gaming state is shifted to the CB gaming state. When “Red 7-Red 7-Red 7” are arranged along the activated line, BB1 becomes a display combination and the flag under BB operation becomes ON, so that the gaming state is shifted to the RB gaming state. When “Blue 7-Blue 7-Blue 7” are arranged along the activated line, BB2 becomes a display combination and the flag under BB operation becomes ON, so that the gaming state is shifted to the RB gaming state.

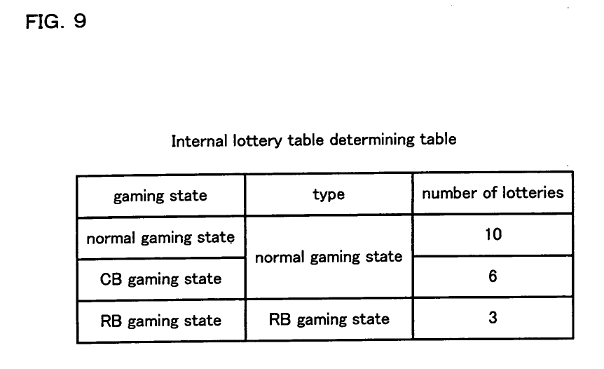

In the followings, it is described an internal lottery table determining table with reference to FIG. 9.

The internal lottery table determining table includes the information about an internal lottery table (see FIG. 10) and the number of lotteries corresponding to the gaming state.

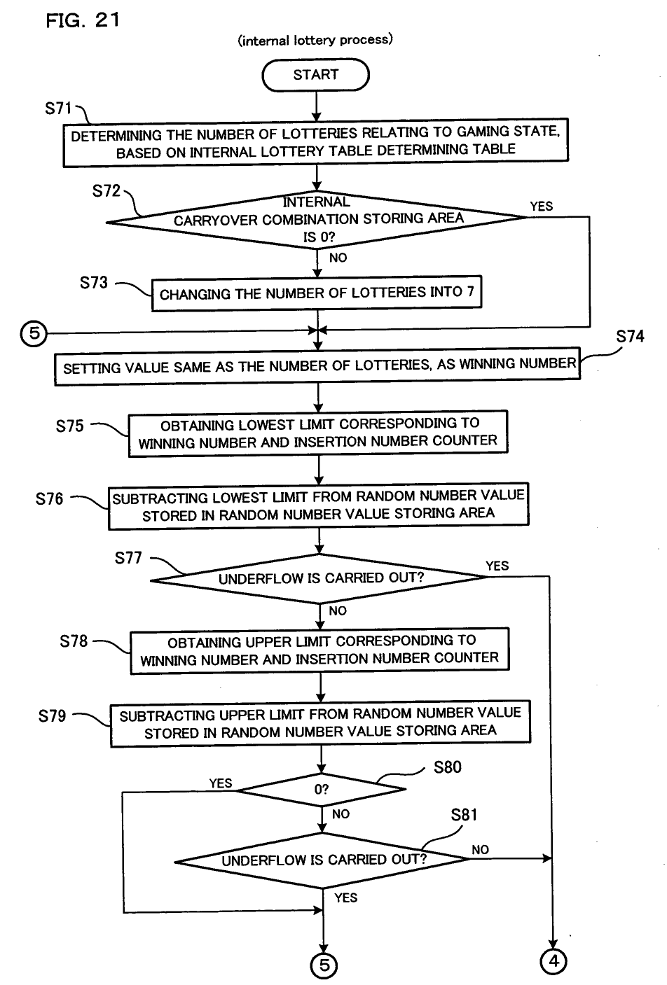

Herein, in case of the normal gaming state, an internal lottery table for a normal gaming state (see FIG. 10A) is selected and “10” is basically determined as the number of lotteries (see a step S71 of FIG. 21). The number of lotteries indicates the number of processes carried out to determine an internal winning combination. Specifically, the number of lotteries is the (maximum) number of calculations of “random number value (R)−lower limit (L)” and “random number value (R)−upper limit (U)”. However, in the case of the carryover section, the number of lotteries determined to be “10” is updated to “7” (see a step S73 of FIG. 21).

In the followings, it is described an internal lottery table with reference to FIG. 10. The internal lottery table is provided every gaming state and includes the information about the numerical range expressed by the lowest and upper limits corresponding to a winning number, for each of the insertion numbers. FIG. 10A shows an internal lottery table for a normal gaming state. FIG. 10B shows an internal lottery table for a RB gaming state. In the RT section, it is basically used the information of the numerical range indicated in the internal lottery table for a normal gaming state. However, when the insertion number is 3 in the RT section, a value of the upper limit corresponding to a winning number 7 is “61513,” rather than “15028.” In other words, a probability that Replay corresponding to the winning number 7 will be determined is “8980/65536” in the non-RT section and “55465/65536” in the RT section. In the mean time, it is omitted an internal lottery table for a CB gaming state.

In the determination (lottery) of a winning number based on the internal lottery table, it is determined whether a random number value is within a numerical range expressed by the lowest and upper limits corresponding to the winning number, from the same winning number as the number of lotteries determined every gaming state to the winning number 0, in descending power. When the random number value is within a numerical range expressed by the lowest and upper limits, a corresponding winning number is determined. In addition, the number of cases where it is determined whether the random number value is within a numerical range expressed by the lowest and upper limits corresponding to a winning number is same as the number of lotteries determined in the internal lottery table determining table of FIG. 9.

In addition, in case that the random number value is never within a numerical range expressed by the lowest and upper limits until the winning number becomes “0,” the winning number becomes 0 (i.e., losing). The losing of the internal winning combination represents that it is not determined a combination matched to a payout to be awarded to the player in the internal lottery. In addition, in one embodiment, the losing is not a combination matched to a game value. Additionally, it may be thought that a symbol combination corresponding to the losing as an internal winning combination is any symbol combination different from the symbol combinations corresponding to the plural combinations preset. However, in one embodiment, it is such structured that a symbol combination corresponding to the losing is not provided.

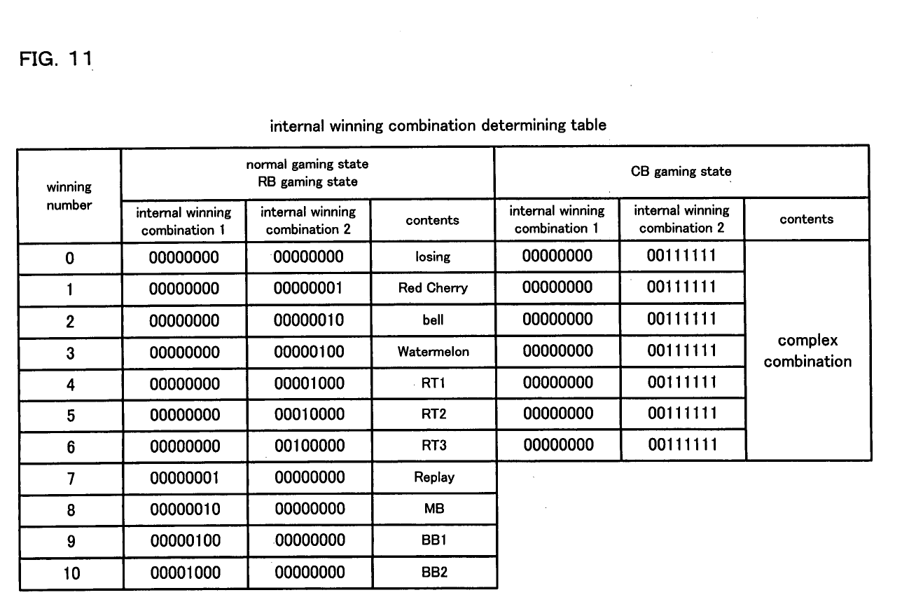

In addition, it is determined whether or not a winning is made, from a winning number, in descending power, until the winning number becomes 0, and it is set that the numerical ranges defined by the lowest and upper limits corresponding to each of the plural combinations are duplicated. Accordingly, plural combinations may be determined as an internal winning combination. An internal winning combination is determined on the basis of the winning number determined, the gaming state, the insertion number and an internal winning combination determining table (see FIG. 11).

For example, in case of the normal gaming state (game section except the carryover section), when the insertion number is 3 and the random number value sampled from the range of 0˜65535 is 1250, “the random number value (R) (1250)−the lowest limit (L) (1696)” is calculated for the winning number 10 first of all. The calculation result is less than 0. Accordingly, since the random number value is not within the numerical range (L≦R≦U) expressed by the lowest and upper limits corresponding to the winning number, when the random number value sampled is 1250, the winning number 10 is not determined.

Next, “the random number value (R) (1250)−the lowest limit (L) (1600)” is calculated for the winning number 9. Accordingly, since the random number value is not within the numerical range (L≦R≦U) expressed by the lowest and upper limits corresponding to the winning number, when the random number value sampled is 1250, the winning number 9 is not determined. Subsequently, “the random number value (R) (1250)−the lowest limit (L) (1152)” is calculated for the winning number 8. The calculation result becomes 0 or more. Next, “the random number value (R) (1250)−the upper limit (U) (1247)” is calculated. This calculation result is greater than 0. Accordingly, since the random number value is not within the numerical range (L≦R≦U) expressed by the lowest and upper limits corresponding to the winning number, when the random number value sampled is 1250, the winning number 8 is not determined.

“The random number value (R) (1250)−the lowest limit (L) (6049)” is calculated for the winning number 7. This calculation result is less than 0. Accordingly, since the random number value is not within the numerical range (L≦R≦U) expressed by the lowest and upper limits corresponding to the winning number, when the random number value sampled is 1250, the winning number 7 is not determined.

“The random number value (R) (1250)−the lowest limit (L) (1248)” is calculated for the winning number 6. Next, “the random number value (R) (1250)−the upper limit (U) (1279)” is calculated. This calculation result is 0 or less. Accordingly, since the random number value is within the numerical range (L≦R≦U) expressed by the lowest and upper limits corresponding to the winning number, when the random number value sampled is 1250, the winning number 6 is determined. When the winning number 6 is determined, RT3 corresponding to the winning number 6 becomes an internal winning combination, based on an internal winning combination determining table which will be described later.

Like this, the calculations of “random number value (R) (1250)−lowest limit (L)” and “random number value (R) (1250)−upper limit (U)” are repeated in descending power until the winning number becomes 0 so as to determine whether each of the winning numbers 5˜1 is determined or not. When the random number value sampled is 1250, the winning numbers 1˜3 and 7˜10 are not determined. Accordingly, RT1, RT2 and RT3 are determined as an internal winning combination, based on an internal winning combination determining table which will be described later.

Herein, in case that it is sampled a random number value within the range from the lowest value 1248 to the upper limit 1279 of the winning number 4 corresponding to RT1, RT2 and RT3 are also determined as an internal winning combination without fail. In addition, in the carryover section, since the number of lotteries is updated to “7” (see a step S73 of FIG. 21), there is no case where the winning numbers “8”˜“10” are determined. Accordingly, in the carryover section, there is no case where the bonus is determined as an internal winning combination on the basis of the internal winning combination determining table which will be described later.

In the followings, it is described an internal winning combination determining table with reference to FIG. 11.

The internal winning combination determining table includes the information (data) about an internal winning combination (flag) corresponding to a winning number. The flag is expressed by a binary number. An internal winning combination 1 and an internal winning combination 2 expressed to correspond to the winning number are the information for identifying an internal winning combination and consist of 1 byte, respectively. The internal winning combination 1 is basically related to an internal carryover combination.

In the normal gaming state and the RB gaming state, when the winning number is 0 and the internal winning combination 2 is “00000000,” the losing is determined as an internal winning combination. When the winning number is 1 and the internal winning combination 2 is “00000001,” an internal winning combination is Red Cherry. When the winning number is 2 and the internal winning combination 2 is “00000010,” an internal winning combination is Bell.

When the winning number is 3 and the internal winning combination 2 is “00000100,” an internal winning combination is Watermelon. When the winning number is 4 and the internal winning combination 2 is “00001000,” an internal winning combination is RT1. When the winning number is 5 and the internal winning combination 2 is “00010000,” an internal winning combination is RT2. When the winning number is 6 and the internal winning combination 2 is “00100000,” an internal winning combination is RT3.

When the winning number is 7 and the internal winning combination 1 is “00000001,” an internal winning combination is Replay. When the winning number is 8 and the internal winning combination 1 is “00000010,” an internal winning combination is MB. When the winning number is 9 and the internal winning combination 1 is “00000100,” an internal winning combination is BB1. When the winning number is 10 and the internal winning combination 1 is “00010000,” an internal winning combination is BB2.

In the CB gaming state, the internal winning combination 2 is “00111111” for any of the winning numbers 0 to 6, and an internal winning combination is a complex combination.

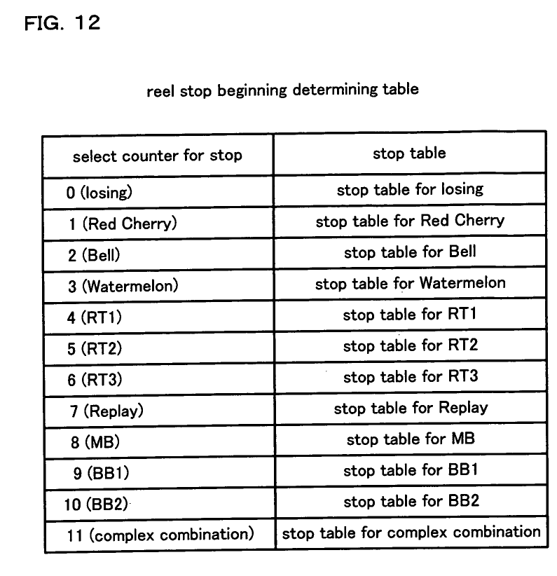

In the followings, it is described a reel stop beginning determination table with reference to FIG. 12.

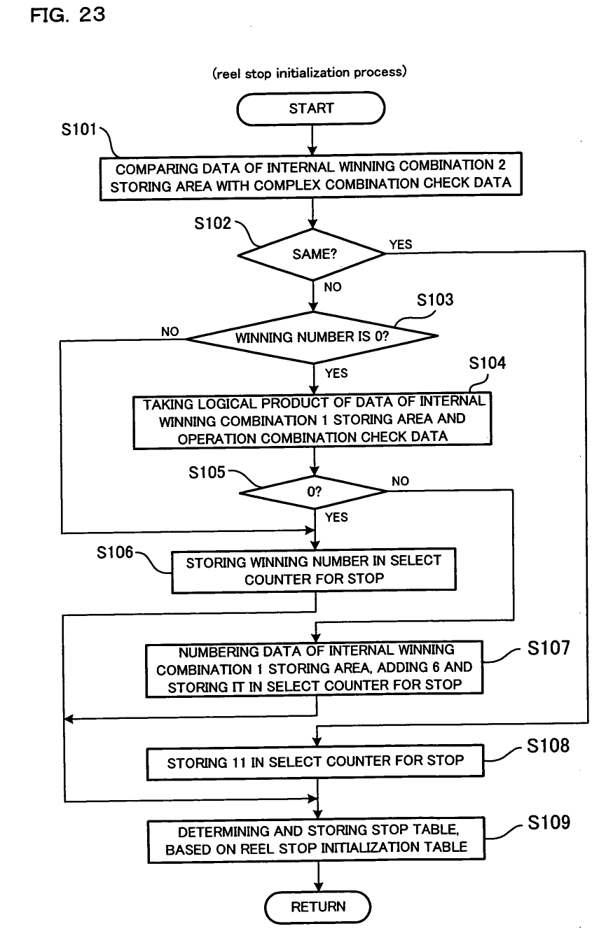

The reel stop beginning determination table includes the information of stop tables corresponding to the respective values 0 to 11 of a select counter for stop. The winning numbers are set in the select counter for stop (see a step S106 in FIG. 23). However, in case that an internal winning combination is a complex combination, 11 is set in the select counter for stop (see a step S108 in FIG. 23).

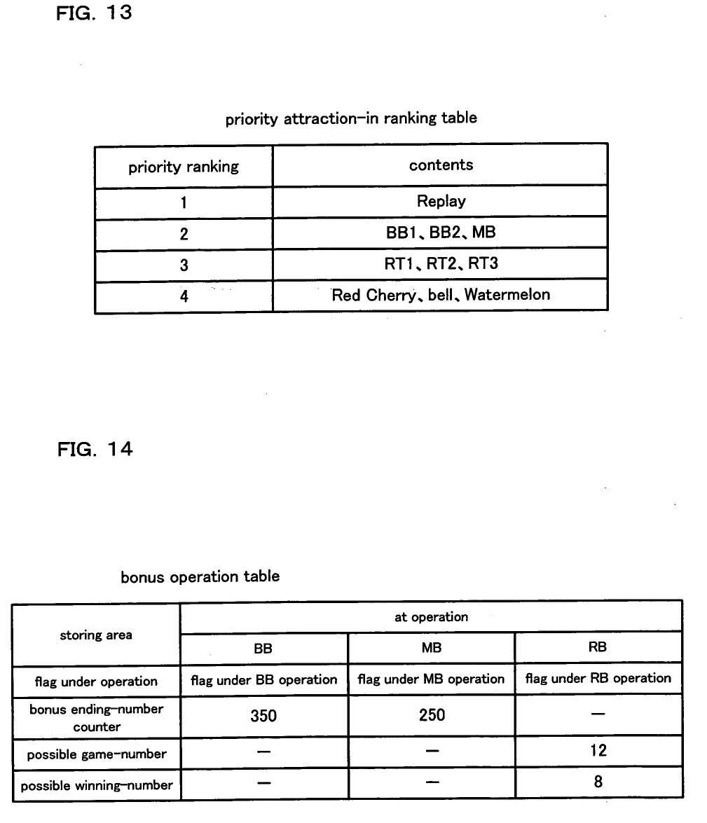

In the followings, a priority attraction-in ranking table is described with reference to FIG. 13.

The priority attraction-in ranking table includes the information of the priority ranking in which “attraction-in” of the symbol combinations corresponding to the combinations is relative. Replay has the highest priority attraction-in ranking. A priority ranking of the bonus is higher than those of the combinations except Replay. Accordingly, in case that the bonus is carried over, Replay is preferentially established when an internal winning of Replay is determined. In the mean time, in case that the bonus is carried over, the bonus is preferentially established when an internal winning of a combination except Replay is determined.

In addition, the priority rankings of RT1, RT2 and RT3 are higher than those of Red Cherry, Bell and Watermelon. Accordingly, in the CB gaming state, it is preferentially carried out the attraction-in of RT1, RT2 and RT3 over Red Cherry, Bell and Watermelon when the stop control of the center and right reels 3C, 3R is carried out.

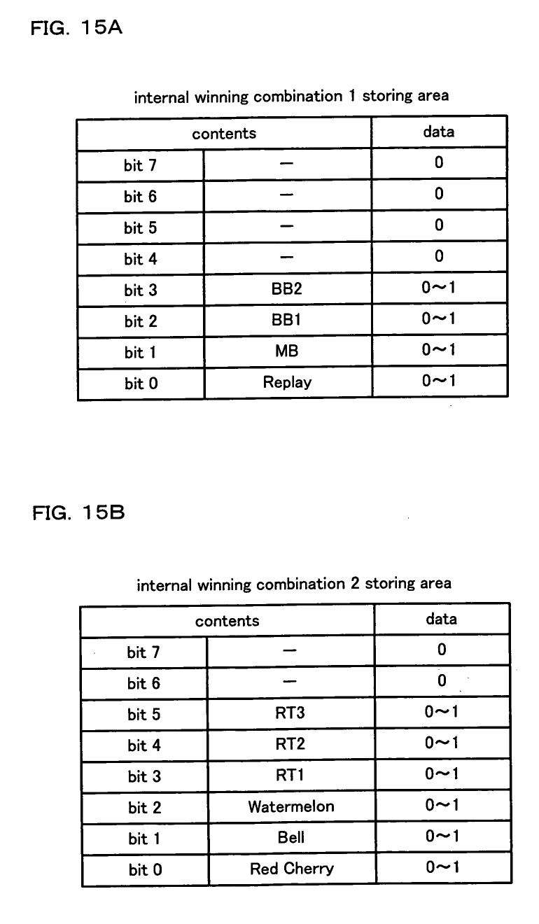

In the followings, it is described a bonus operation table with reference to FIG. 14.

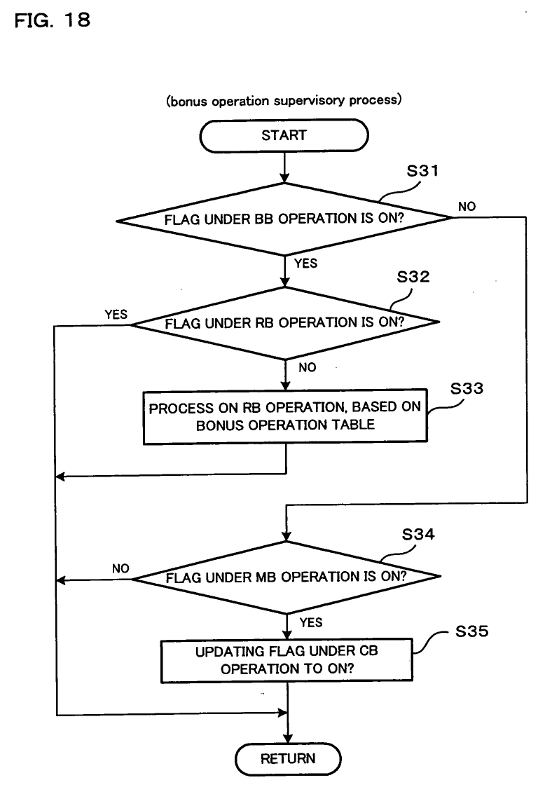

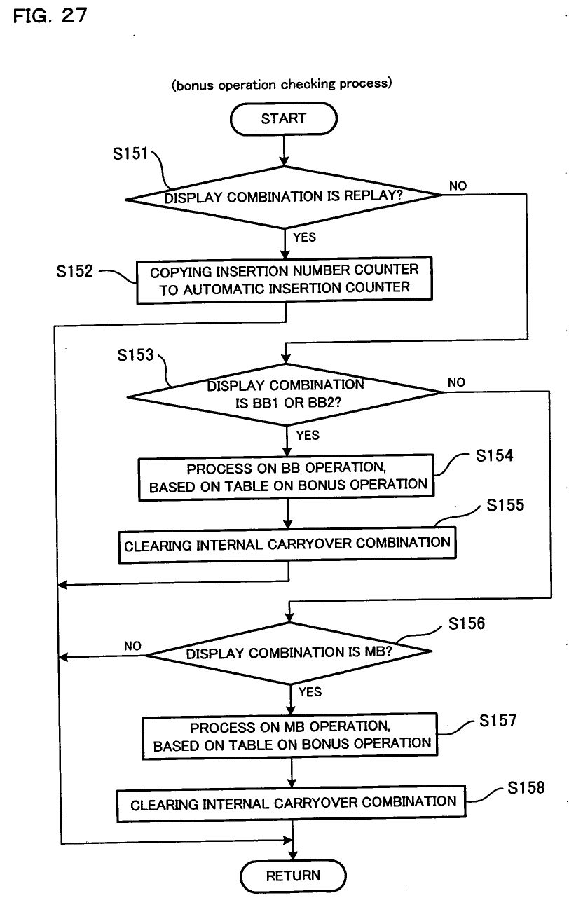

The bonus operation table includes the information of a flag under operation to be updated to ON, a value to be set in the bonus ending-number counter, the possible game-number and the possible winning-number, for each of display combinations. The bonus operation table is referred to in a process of a step S33 in FIG. 18, and processes of steps S154 and S157 in FIG. 27 which will be described later.

The flag under operation is the information for identifying a gaming state being operated (i.e., current gaming state). The flag under operation includes a flag under BB operation, a flag under MB operation and a flag under RB operation in correspondence with a display combination.

The bonus ending-number counter is a counter for counting the number of medals paid out in a game from after the flag under BB operation is updated to ON until it is updated to OFF.

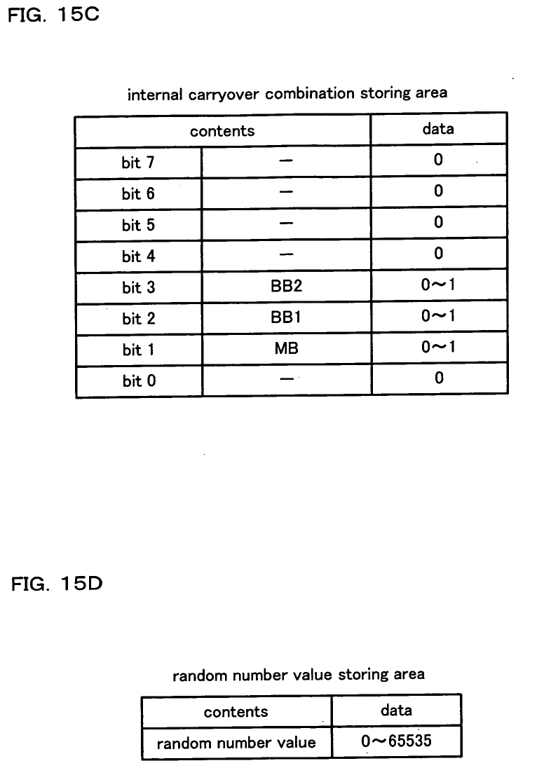

In the followings, it is described areas (memory areas) for storing an internal winning combination 1, an internal winning combination 2, an internal carryover combination and a random number value, with reference to FIG. 15.

FIG. 15A shows an internal winning combination 1 storing area. The information (data) of an internal winning combination is stored (memorized) in the internal winning combination 1 storing area consisting of 1 byte. In the internal winning combination 1 storing area, a bit 0 (first bit) is a storing area corresponding to Replay. A bit 1 (second bit) is a storing area corresponding to MB.

A bit 2 (third bit) is a storing area corresponding to BB1. A bit 3 (fourth bit) is a storing area corresponding to BB2. A bit 4 (fifth bit) to a bit 7 (eighth bit) are unused storing areas. In the internal winning combination 1 storing area, a combination corresponding to a bit which is 1 is an internal winning combination. For example, when “00000010” is stored in the internal winning combination 1 storing area (i.e., when the bit 1 (second bit) is 1), an internal winning combination is MB.

FIG. 15B shows an internal winning combination 2 storing area. The information (data) of an internal winning combination is stored (memorized) in the internal winning combination 2 storing area consisting of 1 byte. In the internal winning combination 2 storing area, a bit 0 (first bit) is a storing area corresponding to Red Cherry. A bit 1 (second bit) is a storing area corresponding to Bell.

A bit 2 (third bit) is a storing area corresponding to Watermelon. A bit 3 (fourth bit) is a storing area corresponding to RT1. A bit 4 (fifth bit) is a storing area corresponding to RT2. A bit 5 (sixth bit) is a storing area corresponding to RT3. A bit 6 (seventh bit) and a bit 7 (eighth bit) are unused storing areas. In the internal winning combination 2 storing area, a combination corresponding to a bit which is 1 is an internal winning combination. For example, when “00000010” is stored in the internal winning combination 2 storing area (i.e., when the bit 1 (second bit) is 1), an internal winning combination is Bell.

FIG. 15C shows an internal carryover combination storing area. The information of an internal carryover combination is stored in the internal carryover combination storing area consisting of 1 byte. In the internal carryover combination storing area, a bit 1 (second bit) is a storing area (memory area) corresponding to MB. In the internal carryover combination storing area, a bit 2 (third bit) is a storing area (memory area) corresponding to BB1. In the internal carryover combination storing area, a bit 3 (fourth bit) is a storing area (memory area) corresponding to BB2. A bit 0 (first bit) and a bit 4 (fifth bit) to a bit 7 (eighth bit) are unused storing areas. When there is an internal carryover combination (when it is under carryover section), 1 is stored in the bit 1 (second bit), the bit 2 (third bit) or the bit 3 (fourth bit) corresponding to MB, BB1 or BB2 of the internal carryover combination storing area (“00000010,” “00000100” or “00001000” is stored in the internal carryover combination storing area).

FIG. 15D shows a random number value storing area (memory area). The random number value storing area is provided in the RAM 33. In the random number value storing area, it is stored the numerical information about the random number for lottery which is sampled in a step S5 of FIG. 16. In a step S6 of FIG. 16, it is sampled the numerical information of one of 0˜65535 as a random number for lottery and the sampled numerical information is stored in the random number value storing area.

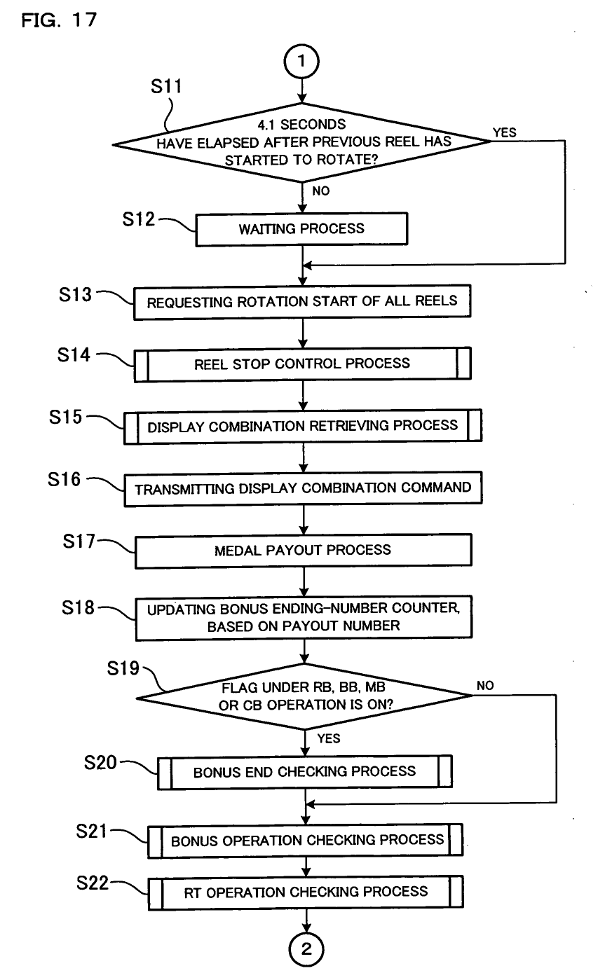

In the followings, it is described a control operation of the main control circuit 71, with reference to flow charts shown in FIGS. 16 and 17.

First, the CPU 31 carries out an initialization process (step S1). Specifically, the CPU initializes the memory contents and communication data of the RAM 33, and then proceeds to a step S2. In the step S2, the CPU erases (clears) predetermined memory contents of the RAM 33. Specifically, the CPU erases the data of the writable area of the RAM 33 used in a previous game, writes a parameter necessary for a next game into the writable area of the RAM 33 and indicates a start address of a sequence program for the next game, etc.

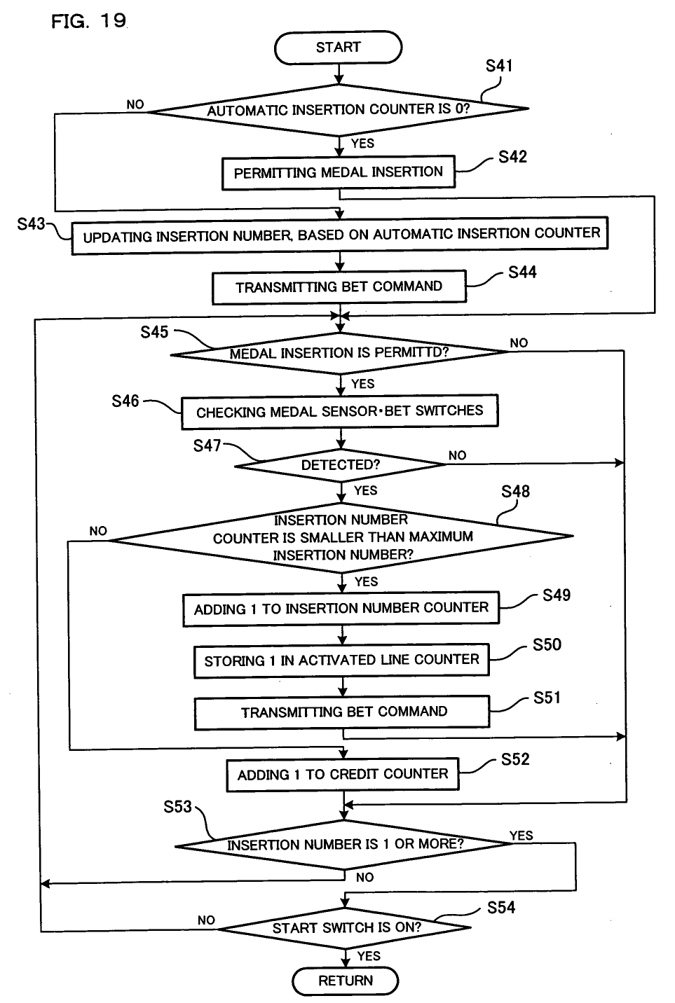

In a step S3, the CPU carries out a bonus operation supervisory process which will be described with reference to FIG. 18, and then proceeds to a step S4. In this process, in case that the flag under BB operation is ON, the CPU carries out a process of updating the flag under RB operation to ON so that the RB gaming state is continued even though the RB gaming state is over. In the step S4, the CPU carries out a medal insertion•start checking process which will be described with reference to FIG. 19, and then proceeds to a step S5. In this process, the CPU updates the bet number, based on the inputs from the start switch 6S, the medal sensor 10S or the BET switches 11 to 13.

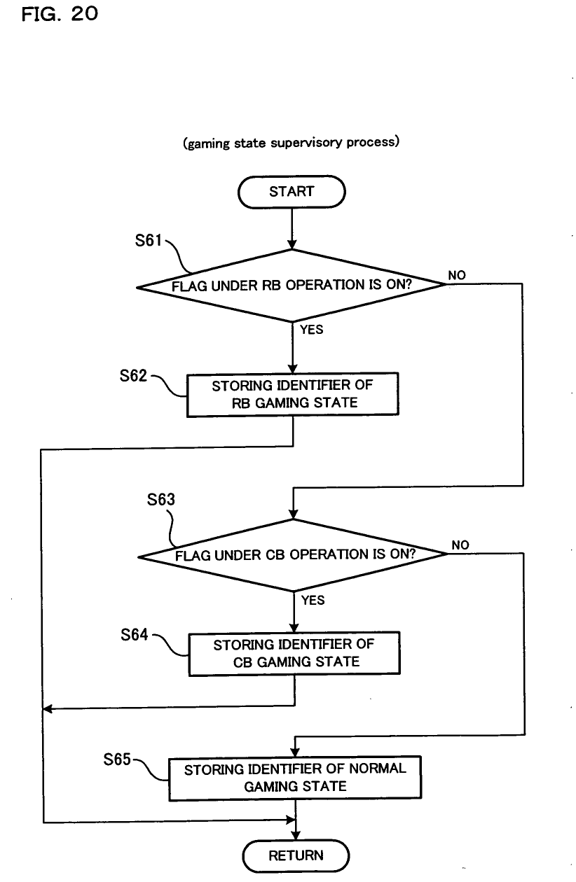

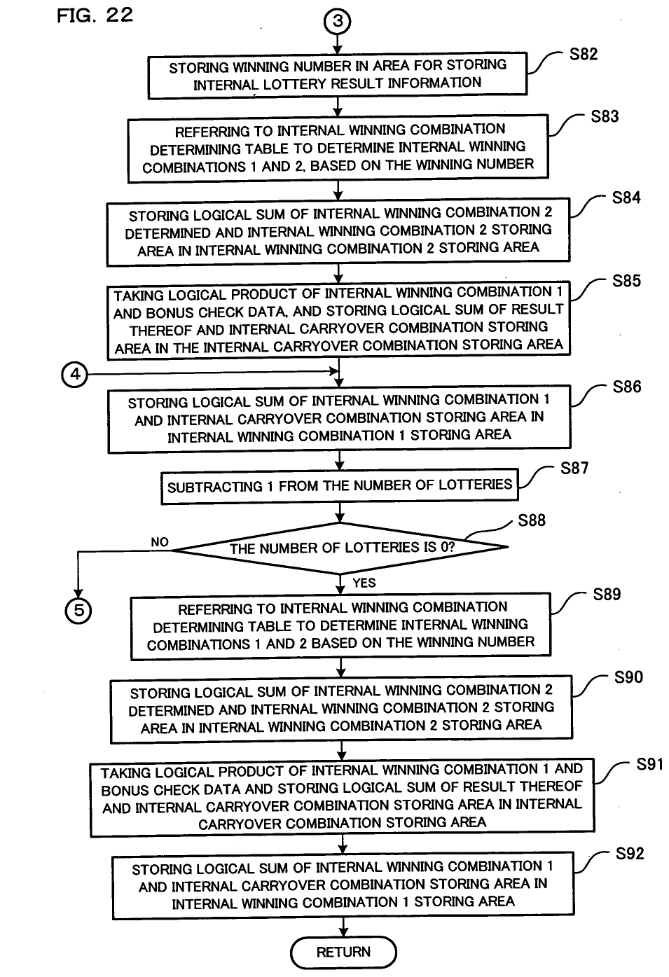

In the step S5, the CPU samples a random number value for lottery, and proceeds to a step S6. The random number value sampled in this process is used for an internal lottery process which will be described later. In the step S6, the CPU carries out a gaming state supervisory process which will be described with reference to FIG. 20, and then proceeds to a step S7. In the step S7, the CPU carries out an internal lottery process which will be described with reference to FIGS. 21 and 22, and then proceeds to a step S8. In the step S8, the CPU carries out a reel stop initialization process which will be described with reference to FIG. 23, and then proceeds to a step S9.

In the step S9, the CPU transmits a start command and then proceeds to a step S1. The start command contains the information of a gaming state, an internal winning combination, etc., and is transmitted to the sub-control circuit 72. In the step S10, the CPU carries out a subtraction process of the RT game-number counter and then proceeds to a step S11 in FIG. 11. In the subtraction process of the RT game-number counter, the CPU carries out the process of subtracting 1 from the RT game-number counter when the value of the counter is 1 or more.

In the step S11 of FIG. 17, the CPU determines whether “4.1 seconds” have elapsed after the reel has started to rotate in the previous game. When a result of the determination is YES, the CPU proceeds to a step S13, otherwise proceeds to a step S12. In the step S12, the CPU consumes a game start waiting time (waiting process) and then proceeds to a step S13. Specifically, the CPU annuls an input related to a game start operation by a player during the period from after the previous game has started until a predetermined time (for example, 4.1 seconds) has elapsed.

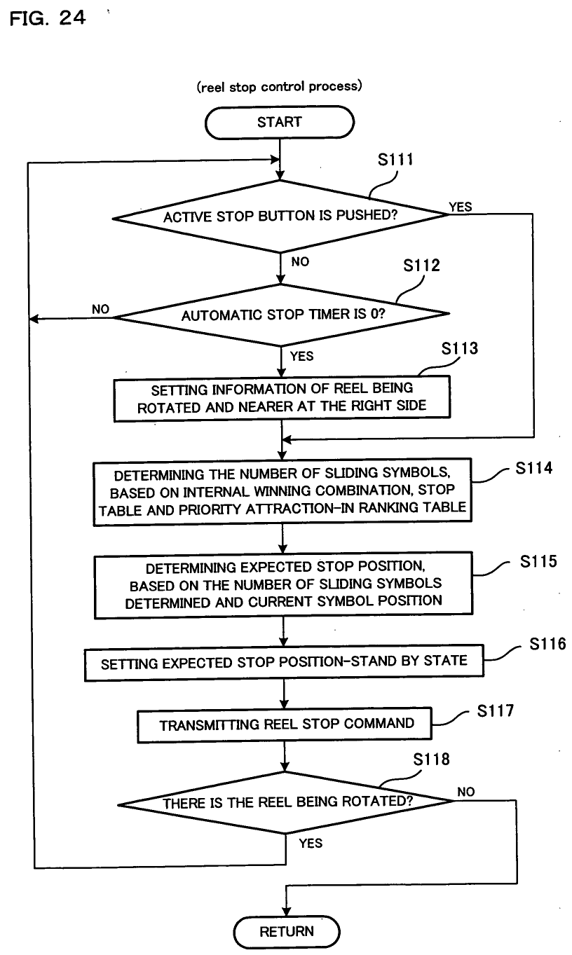

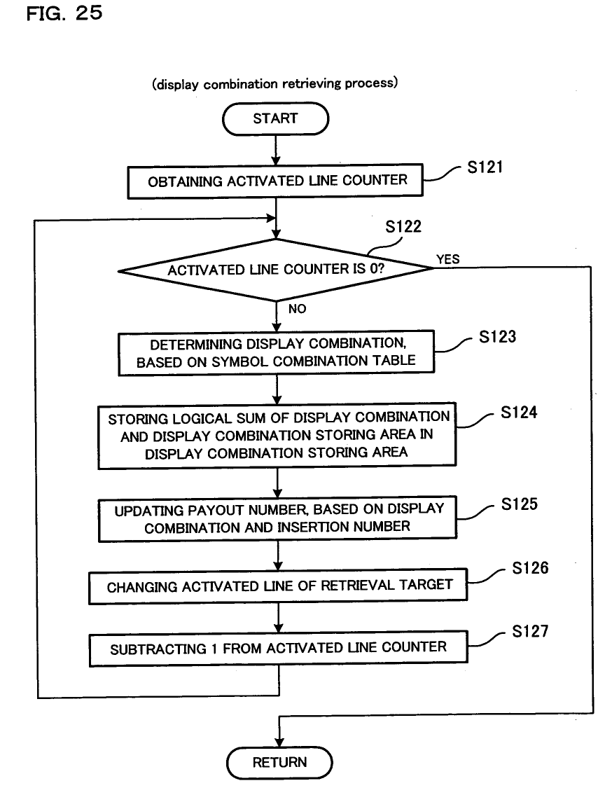

In the step S13, the CPU requests the rotation start of all reels, and then proceeds to a step S14. In the step S14, the CPU carries out a reel stop control process which will be described with reference to FIG. 24, and then proceeds to a step S15. In the step S15, the CPU carries out a display combination retrieving process which will be described with reference to FIG. 25, and then proceeds to a step S16. In the step S16, the CPU transmits a display combination command, and then proceeds to a step S17.

In the step S17, the CPU carries out a medal payout process, and then proceeds to a step S18. In the step S18, the CPU updates the bonus ending-number counter based on the payout number, and then proceeds to a step S19. In this process, when the bonus ending-number counter is 1 or more, the CPU subtracts the counter depending on the payout number of medals. In the step S19, the CPU determines whether the flag under RB operation, the flag under BB operation, the flag under MB operation or the flag under CB operation is ON or not. When a result of the determination is YES, the CPU proceeds to a step S20, otherwise proceeds to a step S21.

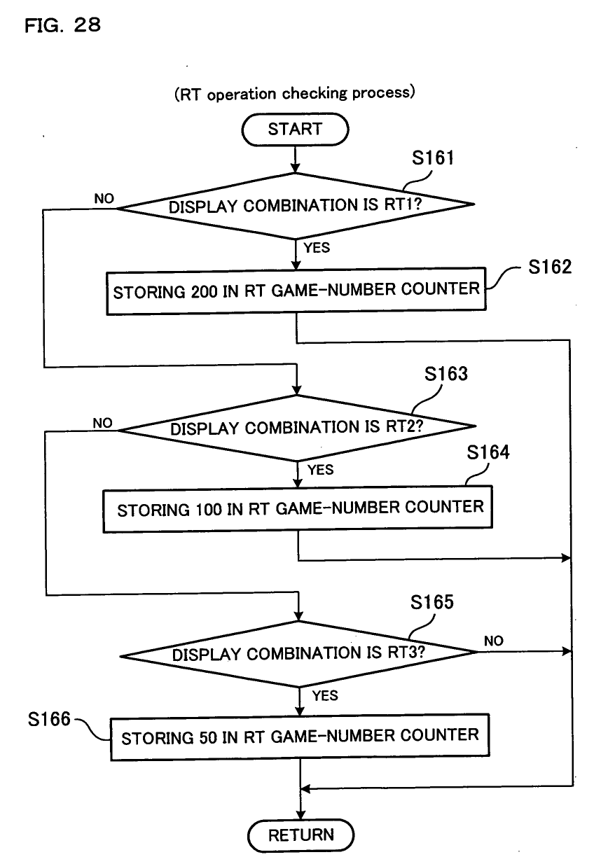

In the step S20, the CPU carries out a bonus end checking process which will be described with reference to FIG. 26, and then proceeds to a step S21. In the step S21, the CPU carries out a bonus operation checking process which will be described with reference to FIG. 27, and then proceeds to the step S22. In the step S22, the CPU carries out a RT operation checking process which will be described with reference to FIG. 28, and then proceeds to the step S2 in FIG. 16.

In the followings, it is described a bonus operation supervisory process with reference to FIG. 18.

First, the CPU 31 determines whether the flag under BB operation is ON or not (step S31). When a result of the determination is YES, the CPU proceeds to a step S32, otherwise proceeds to a step S34. In the step S32, the CPU determines whether the flag under RB operation is ON or not. When a result of the determination is YES, the CPU proceeds to the step S4 in FIG. 16, otherwise proceeds to a step S33.

In the step S33, the CPU carries out a process on RB operation, based on the bonus operation table (see FIG. 14), and then proceeds to the step S4 in FIG. 16. Specifically, the CPU updates the flag under RB operation to ON, and stores the possible game-number and the possible winning-number in the RAM 33. In the step S34, the CPU determines whether the flag under MB operation is ON or not. When a result of the determination is YES, the CPU proceeds to a step S35, otherwise proceeds to the step S4 in FIG. 16. In the step S35, the CPU updates the flag under CB operation to ON, and then proceeds to the step S4 in FIG. 16. In other words, after MB is established, the CB gaming state is maintained until the flag under MB operation is updated to OFF.

In the followings, a medal insertion•start checking process is described with reference to FIG. 19.

First, the CPU 31 determines whether an automatic insertion counter is 0 or not, i.e., whether Replay has been established in the previous game (step S41). When a result of the determination is YES, the CPU proceeds to a step S42, otherwise proceeds to a step S43. The automatic insertion counter is a counter for counting the number of medals which are automatically inserted when a display combination is Replay. In the step S42, the CPU permits the insertion of medal and then proceeds to a step S45. In the step S43, the CPU updates the insertion number (insertion number counter), based on the automatic insertion counter, and then proceeds to a step S44. The insertion number counter is a counter for counting the number of medals inserted.

In the step S44, the CPU 31 transmits the BET command, and then proceeds to a step S45. In the step S45, the CPU determines whether it is permitted the insertion of medal or not. When a result of the determination is YES, the CPU proceeds to a step S46, otherwise proceeds to a step S53. In the step S46, the CPU checks the medal sensor and the BET switches, and then proceeds to a step S47. Specifically, the CPU checks the inputs from the medal sensor 10S or BET switches 11 to 13.

In the step S47, the CPU determines whether it is detected signals from the medal sensor and the BET switches, i.e., whether a medal is inserted or not. Specifically, the CPU determines whether or not it is detected signals from the medal sensor 10S or BET switches 11 to 13. When a result of the determination is YES, the CPU proceeds to a step S48, otherwise proceeds to a step S53. In the step S48, the CPU determines whether the value of the insertion number counter is smaller than the maximum insertion number. When a result of the determination is YES, the CPU proceeds to a step S49, otherwise proceeds to a step S52.

In the step S49, the CPU adds 1 to the insertion number counter and then proceeds to a step S50. In the step S50, the CPU stores 5 in an activated line counter and then proceeds to a step S51. The activated line counter is a counter for counting the number of activated lines for which it is carried out a determination of the display combination, among the plural activated lines. In the step S51, the CPU transmits the BET command and then proceeds to a step S53. In the step S52, the CPU adds 1 to the credit counter and then proceeds to a step S53.

In the step S53, the CPU determines whether the insertion number is 1 or more. When a result of the determination is YES, the CPU proceeds to a step S54, otherwise proceeds to the step S45. In the step S54, the CPU determines whether the start switch is ON or not. When a result of the determination is YES, the CPU proceeds to the step S5 in FIG. 16, otherwise proceeds to the step S45.

In the followings, it is described a gaming state supervisory process with reference to FIG. 20.

First, the CPU 31 determines whether the flag under RB operation is ON or not (step S61). When a result of the determination is YES, the CPU proceeds to a step S62, otherwise proceeds to a step S63. In the step S62, the CPU stores an identifier of the RB gaming state and then proceeds to the step S7 in FIG. 16.

In the step S63, the CPU 31 determines whether the flag under CB operation is ON or not. When a result of the determination is YES, the CPU proceeds to a step S64, otherwise proceeds to a step S65. In the step S64, the CPU stores an identifier of the CB gaming state and then proceeds to the step S7 in FIG. 16. In the step S65, the CPU stores an identifier of the normal gaming state and then proceeds to the step S7 in FIG. 16. Like this, in the gaming state supervisory process, the CPU supervises the gaming state, based on the flag under operation (flag under RB operation, flag under CB operation), and stores the information for selecting a type of an internal lottery table determining table relating to the gaming state in the RAM 33 (gaming state storing area) in a step S71 of FIG. 21.

In the followings, it is described an internal lottery process with reference to FIGS. 21 and 22.

First, the CPU 31 determines the number of lotteries relating to the gaming state, based on the internal lottery table determining table (see FIG. 9) (step S71), and then proceeds to a step S72. In the step S72, the CPU determines whether the data (information) stored in the internal carryover combination storing area is 0 or not (i.e., whether or not there is an internal carryover combination). When a result of the determination is YES, the CPU proceeds to a step S74, otherwise proceeds to a step S73. Herein, a result of the determination in the step S72 is NO in case of the carryover section. In the step S73, the CPU changes the number of lotteries into 7, and then proceeds to a step S74.

In the step S74, the CPU 31 sets a value same as the number of lotteries in the register of the CPU, as a winning number, and then proceeds to a step S75. Thereby, as the winning number, “10” is set in the normal gaming state, “6” is set in the CB gaming state, “3” is set in the RB gaming state and “7” is set in the internal winning state (carryover section). In the step S75, the CPU refers to the internal lottery table corresponding to the gaming state determined in the step S71 to obtain the lowest limit (U), based on the winning number and the insertion number, and then proceeds to a step S76. In the step S76, the CPU subtracts the lowest limit (L) from the random number value (R) stored in the random number value storing area of the RAM 33 (R−L), and then proceeds to a step S77.

In the step S77, the CPU determines whether or not it is carried out an underflow. Specifically, the CPU determines whether the calculation result of R−L is negative or not. When a result of the determination is YES, the CPU proceeds to a step S86 in FIG. 22, otherwise proceeds to a step S78. The result of determination becomes YES when the random number value is smaller than the lowest limit (L>R). In addition, the result of determination becomes NO when the random number value is equal to or greater than the lowest limit (L≦R).

In the step S78, the CPU refers to the internal lottery table corresponding to the gaming state determined in the step S71 to obtain the upper limit (U), based on the winning number and the insertion number, and then proceeds to a step S79. In the step S79, the CPU subtracts the upper limit (U) from the random number value (R) stored in the random number value storing area of the RAM 33 (R−U), and then proceeds to a step S80.

In the step S80, the CPU determines whether a value resulting from the subtraction, i.e., the calculation result of R−U is “0” or not. When a result of the determination is YES, the CPU proceeds to a step S82 in FIG. 22, otherwise proceeds to a step S81. The result of determination becomes YES when the random number value is equal to the upper limit (R=U). In addition, the result of determination becomes NO when the random number value is not equal to the upper limit (L≠R).

In the step S81, the CPU determines whether or not it is carried out an underflow. Specifically, the CPU determines whether the calculation result of R−U is negative or not. When a result of the determination is YES, the CPU proceeds to a step S82 in FIG. 22, otherwise proceeds to a step S86 in FIG. 22. The result of determination becomes YES when the random number value is smaller than the upper limit (R<U). In addition, the result of determination becomes NO when the random number value is greater than the upper limit (R>U).

In the step S82 of FIG. 22, the CPU stores the winning number in an area for storing internal lottery result information of the RAM 33, and then proceeds to a step S83. In the step S83, the CPU refers to the internal winning combination determining table to determine internal winning combinations 1 and 2, based on the winning number, and then proceeds to a step S84. In the step S84, the CPU stores a logical sum of the internal winning combination 2 determined in the step S83 and the internal winning combination 2 storing area (FIG. 15B) in the internal winning combination 2 storing area. Herein, it is established a bit corresponding to a type of Small Win which is won in the internal winning combination 2 storing area.

In the step S85, the CPU takes a logical product of the internal winning combination 1 and the bonus check data, stores a logical sum of a result thereof and the internal carryover combination storing area in the internal carryover combination storing area, and then proceeds to a step S86. Thereby, the bonus determined is stored in the internal carryover combination storing area. In addition, the bonus check data is “00000110.” In the step S86, the CPU stores a logical sum of the internal winning combination 1 and the internal carryover combination storing area in the internal winning combination 1 storing area, and then proceeds to a step S87.

In the step S87, the CPU subtracts 1 from the number of lotteries and then proceeds to a step S88. In the step S88, the CPU determines whether or not the number of lotteries is 0. When a result of the determination is YES, the CPU proceeds to a step S89, otherwise proceeds to the step S74 in FIG. 21. The result of determination becomes YES when the number of cases where it is determined whether or not the random number value (R) is within the numerical range defined by the upper limit (U) and the lowest limit (L) is 10 times in the normal gaming state, 6 times in the CB gaming state, 3 times in the RB gaming state and 7 times in the internal winning state (carryover section). In the mean time, the result of determination becomes NO when the number of determination cases is less than 10 times in the normal gaming state, less than 6 times in the CB gaming state, less than 3 times in the RB gaming state and less than 7 times in the internal winning state (carryover section).

In the step S89, the CPU refers to the internal winning combination determining table (see FIG. 11) to determine the internal winning combinations 1 and 2 based on the winning number, and then proceeds to a step S90. In the step S90, the CPU stores a logical sum of the internal winning combination 2 determined and the internal winning combination 2 storing area (see FIG. 15B) in the internal winning combination 2 storing area. In the step S91, the CPU takes a logical product of the internal winning combination 1 and the bonus check data, stores a logical sum of a result thereof and the internal carryover combination storing area in the internal carryover combination storing area, and then proceeds to a step S92. Thereby, the internal carryover combination is stored in the internal carryover combination storing area. In the step S92, the CPU stores a logical sum of the internal winning combination 1 and the internal carryover combination storing area in the internal winning combination 1 storing area and then proceeds to the step S8 in FIG. 16. As a result, when the random number value (R) is not within any numerical ranges of the internal lottery table in FIG. 10 and the processes in the steps S82˜S85 are not carried out, the losing or internal carryover combination is stored in the internal winning combination 1 storing area.

In the followings, a reel stop initialization process is described with reference to FIG. 23.

First, the CPU 31 compares the data of the internal winning combination 2 storing area with the complex combination check data (“00111111”) (step S101), and then proceeds to a step S102. In the step S102, the CPU determines whether or not the data of the internal winning combination 2 storing area is equal to the complex combination check data. When a result of the determination is YES (i.e., when the internal winning combination is the complex combination), the CPU proceeds to a step S108, otherwise proceeds to a step S103.

In the step S103, the CPU 31 determines whether or not the winning number is 0. When a result of the determination is YES, the CPU proceeds to a step S104, otherwise proceeds to a step S106. In the step S104, the CPU takes a logical product of the data of the internal winning combination 1 storing area and the operation combination check data (“00001111”), and then proceeds to a step S105. In the step S105, the CPU determines whether the logical product is 0 or not. When a result of the determination is YES, the CPU proceeds to a step S106, otherwise (i.e., when there is Replay or an internal carryover combination) proceeds to a step S107.

In the step S106, the CPU stores the winning number in the select counter for stop, and then proceeds to a step S109. In the step S107, the CPU numbers the data of the internal winning combination 1 storing area, adds 6, stores it in the select counter for stop and then proceeds to a step S109. The numbering is as follows: when the bit 0 is ON (1 is stored in the bit 0), 1 is set, when the bit 1 is ON (1 is stored in the bit 1), 2 is set, and when the bit 2 is ON (1 is stored in the bit 2), 3 is set. Specifically, when the data of the internal winning combination 1 storing area represents Replay, MB1, BB1 or BB2, 7, 8, 9 and 10 are stored in the select counter for stop, in the respective cases. In the step S108, the CPU stores 11 in the select counter for stop and then proceeds to a step S109. In the step S109, the CPU determines and stores a stop table, based on the reel stop initialization table, and then proceeds to the step S9 in FIG. 16.

In the followings, it is described a reel stop control process with reference to FIG. 24.

First, the CPU 31 determines whether or not an active stop button is pushed, i.e., whether or not there is an input from the stop switches 7LS, 7CS, 7RS (step S111). When a result of the determination is YES, the CPU proceeds to a step S114, otherwise proceeds to a step S112. In the step S112, the CPU determines whether or not the automatic stop timer is 0. When a result of the determination is YES, the CPU proceeds to a step S113, otherwise proceeds to the step S111.

In the step S113, the CPU sets the information of the reel which is nearer at the right side and being rotated, and then proceeds to a step S114. By the information, for example, when the plural reels are being rotated, the reels are stopped from the right side. In the step S114, the CPU determines the number of sliding symbols, based on the internal winning combination, the stop table and the priority attraction-in ranking table, and then proceeds to a step S115. In the step S115, the CPU determines an expected stop position (position for stopping the symbol), based on the determined number of sliding symbols and the current symbol position, and then proceeds to a step S116. In the step S116, the CPU shifts to an expected stop position-stand by state, and then proceeds to a step S117.

In the step S117, the CPU transmits a reel stop command and then proceeds to a step S118. In the step S18, the CPU determines whether there is a reel being rotated. When a result of the determination is YES, the CPU proceeds to the step S111, otherwise proceeds to the step S15 in FIG. 17.

In the followings, it is described a display combination retrieving process with reference to FIG. 25.

First, the CPU 31 obtains the activated line counter (step S121) and then proceeds to a step S122. When a game is started, 5 is stored in the activated line counter (step S50 in FIG. 19). In the step S122, the CPU determines whether the activated line counter is 0 or not. When a result of the determination is YES, the CPU proceeds to the step S16 in FIG. 17, otherwise proceeds to a step S123. When it is ended the retrieval of the display combination for all of the five activated lines, the value of the activated line counter becomes 0.

In the step S123, the CPU determines a display combination, based on the symbol combination table (see FIG. 8), and then proceeds to a step S124. In the step S124, the CPU stores a logical sum of the display combination and the display combination storing area in the display combination storing area, and then proceeds to a step S125. In the step S125, the CPU updates the payout number, based on the display combination and the insertion number, and then proceeds to a step S126. In the step S126, the CPU changes the activated line of the retrieval target, and then proceeds to a step S127. In the step S127, the CPU subtracts 1 from the activated line counter and then proceeds to the step S122.

In the followings, a bonus end checking process is described with reference to FIG. 26.

First, the CPU 31 determines whether the flag under RB operation is ON or not (step S131). When a result of the determination is YES, the CPU proceeds to a step S134, otherwise proceeds to a step S132. In the step S132, the CPU updates the flag under CB operation to OFF, and then proceeds to a step S133. In the step S133, the CPU determines whether the bonus ending-number counter is 0 or not. When a result of the determination is YES, the CPU proceeds to a step S137, otherwise proceeds to the step S21 in FIG. 17.

In the step S134, the CPU determines whether a winning is made or not. When a result of the determination is YES, the CPU proceeds to a step S135, otherwise proceeds to a step S142. In the step S135, the CPU determines whether the bonus ending-number counter is 0 or not. When a result of the determination is YES, the CPU proceeds to a step S136, otherwise proceeds to a step S140.

In the step S136, the CPU carries out a process on RB ending, and then proceeds to a step S137. Specifically, the CPU clears the flag under RB operation, the possible winning-number and the possible game-number and the like. In the step S137, the CPU carries out a process on bonus ending and then proceeds to a step S138. Specifically, the CPU clears the flag under BB operation, the bonus ending-number counter and the like. In the step S138, the CPU determines whether it is at the end time of BB. When a result of the determination is YES, the CPU proceeds to a step S139, otherwise proceeds to the step S21 in FIG. 17. In the step S139, the CPU stores 50 in the RT game-number counter and then proceeds to the step S21 in FIG. 17.

In the step S140, the CPU subtracts 1 from the possible winning-number, and then proceeds to a step S141. In the step S141, the CPU determines whether the possible winning-number is 0 or not. When a result of the determination is YES, the CPU proceeds to a step S144, otherwise proceeds to a step S142. In the step S142, the CPU subtracts 1 from the possible game-number, and then proceeds to a step S143. In the step S143, the CPU determines whether the possible game-number is 0 or not. When a result of the determination is YES, the CPU proceeds to a step S144, otherwise proceeds to the step S21 in FIG. 17. In the step S144, the CPU carries out the process on RB ending, and then proceeds to the step S21 in FIG. 17.

In the followings, a bonus operation checking process is described with reference to FIG. 27.

First, the CPU 31 determines whether or not the display combination is Replay (step S151). When a result of the determination is YES, the CPU proceeds to a step S152, otherwise proceeds to a step S153. In the step S152, the CPU copies the insertion number counter to the automatic insertion counter and then proceeds to the step S22 in FIG. 17. Specifically, in the step S152, the CPU sets (automatically inserts) the number same as the insertion number inserted to play this game to the automatic insertion counter.

In the step S153, the CPU determines whether the display combination is BB1 or BB2. When a result of the determination is YES, the CPU proceeds to a step S154, otherwise proceeds to a step S156. In the step S154, the CPU carries out a process on BB operation, based on the bonus operation table, and then proceeds to a step S155. In the process on BB operation, the CPU updates the flag under BB operation to ON, and sets 350 in the bonus ending-number counter.

In the step S155, the CPU clears the internal carryover combination and then proceeds to the step S22 in FIG. 17. In the step S156, the CPU determines whether the display combination is MB or not. When a result of the determination is YES, the CPU proceeds to a step S157, otherwise proceeds to the step S22 in FIG. 17. In the step S157, the CPU carries out a process on MB operation, based on the bonus operation table, and then proceeds to a step S158. In the process on MB operation, the CPU updates the flag under MB operation to ON, and sets 250 in the bonus ending-number counter. In the step S158, the CPU clears the internal carryover combination and then proceeds to the step S22 in FIG. 17. In addition, in the steps S155 and S158, the CPU may clear (i.e., store 0) the RT game-number counter while clearing the internal carryover combination.

In the followings, it is described a RT operation checking process with reference to FIG. 28.

First, the CPU 31 determines whether the display combination is RT1 or not (step S161). When a result of the determination is YES, the CPU proceeds to a step S162, otherwise proceeds to a step S163. In the step S162, the CPU stores 200 in the RT game-number counter and then proceeds to the step S2 in FIG. 16. In the step S163, the CPU 31 determines whether the display combination is RT2 or not. When a result of the determination is YES, the CPU proceeds to a step S164, otherwise proceeds to a step S165. In the step S164, the CPU stores 100 in the RT game-number counter and then proceeds to the step S2 in FIG. 16.

In the step S165, the CPU 31 determines whether the display combination is RT3 or not. When a result of the determination is YES, the CPU proceeds to a step S166, otherwise proceeds to the step S2 in FIG. 16. In the step S166, the CPU stores 50 in the RT game-number counter and then proceeds to the step S2 in FIG. 16. Like this, in the steps S161˜S166, when the display combination is RT, the information (one of 200, 100 and 50) about the number of times defined to correspond to RT1, RT2 and RT3 is stored in the RT game-number counter.

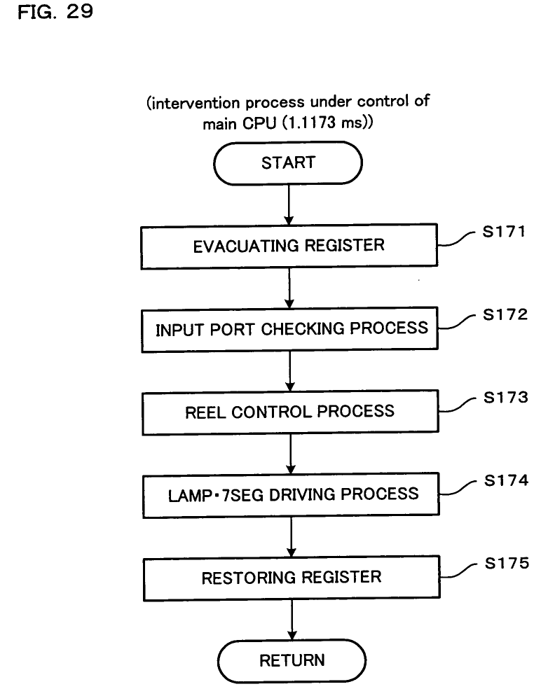

In the followings, it is described an intervention process under control of the main CPU (CPU 31), with reference to FIG. 29. The intervention process is carried out every 1.1173 ms.

First, the CPU 31 evacuates a register (step S171), and then proceeds to a step S172. In the step S172, the CPU checks an input port and then proceeds to a step S173. Specifically, the CPU checks whether there is a signal input from the start switch 6S resulting from the push operation of the start lever 6. In the step S173, the CPU carries out a reel control process, and then proceeds to a step S174. Specifically, the CPU sets the information representing the control target reel as an identifier of a reel, and controls the driving of the reel.

In the step S174, the CPU performs a lamp•7SEG driving process, and then proceeds to a step S175. Specifically, the CPU 31 turns on the BET lamps 17a to 17c, based on the number of medals bet per a game. In addition, the CPU displays the number of medals deposited (credited) and the payout number when a combination is established on the credit display unit 19. In the step S175, the CPU restores the register and then ends the periodic intervention process.

The invention has been described with reference to the embodiments. However, the invention is not limited thereto.

In the embodiment, in the symbol arrangement of the right reel 3R, “Red 7,” “Blue 7” and “BAR” are respectively arranged at an interval of 5 symbols. However, the invention is not limited thereto. For example, in the symbol arrangement of the right reel 3R, it may be such structured that two “Red 7's” are successively arranged, three “Blue 7's” are successively arranged and four “BARs” are successively arranged and “Red 7,” “Blue 7” and “BAR” are respectively arranged at an interval of 4 symbols. By doing so, the maximum number of sliding symbols becomes 4. Accordingly, when RT1, RT2 and RT3 are determined as an internal winning combination by the lottery of one time, any one of symbol combinations corresponding to RT1, RT2 and RT3 is displayed along the activated line (in other words, there is no unexpected missing of RT), irrespective of the timing of the stop operation corresponding to the right reel 3R. Accordingly, the player can carry out the stop operation with the aiming of a desired symbol combination while feeling at rest.

In addition, for example, it may be such structured that the bell corresponding to “Bell-Bell-Bell” is made to be RT4 and the upper and lowest limits corresponding to RT4 are same as RT1, RT2 and RT3. In addition, it is preferred that the priority ranking corresponding to RT4 is lower than those of RT1, RT2 and RT3, and the number of games of the RT section, which results from that the symbol combination corresponding to RT4 is displayed along the activated line, is smaller than those in RT1, RT2 and RT3.

By doing so, since the maximum number of sliding symbols is 4, when RT1, RT2, RT3 and RT4 are determined as an internal winning combination by the lottery of one time, any one of symbol combinations corresponding to RT1, RT2, RT3 and RT4 is displayed along the activated line (in other words, there is no unexpected missing of RT), irrespective of the timing of the stop operation corresponding to the right reel 3R. Accordingly, the player can carry out the stop operation with the aiming of a desired symbol combination while feeling at rest.

In the embodiment, in the symbol arrangement of the right reel 3R, one “Red 7” is arranged, two “Blue 7's” are successively arranged and three “BARs” are successively arranged. However, the invention is not limited thereto. For example, similarly to the right reel 3R, it may be such structured that one “Red 7” is arranged, two “Blue 7's” are successively arranged and three “BARs” are successively arranged, with regard to the left reel 3L and the center reel 3C. In addition, it is necessarily structured such that the symbol combination corresponding to BB (“Red 7-Red 7-Red 7,” “Blue 7-Blue 7-Blue 7”) should correspond to another symbol combination (for example, “Watermelon-Watermelon-Red 7,” “Watermelon-Watermelon-Blue 7”).

By doing so, when it is informed that RT1, RT2 and RT3 are determined as an internal winning combination by the lottery of one time, the player can make progress the game with being strained in all the stop operations (first stop operation, second stop operation and third stop operation). In addition, since it is different the number of games of the RT section caused by all the stop operations, it is possible to change the degree of difficulty of the stop operation (so-called technique intervention characteristics), thereby excluding the source causing the game to be monotonous.

In the embodiment, the internal lottery table (not shown) for a CB gaming state is structured such that RT1, RT2 and RT3 are determined in the CB gaming state. However, the invention is not limited thereto. For example, the internal lottery table for a CB gaming state may be structured such that RT1, RT2 and RT3 are not determined in the CB gaming state. By doing so, since there is no case where the CB gaming state is over in the course of the game and thus the RT section is made, it is possible to secure the payout to be obtained in the CB gaming state (the number of medals obtained).

In addition, the invention can be applied to another gaming machine such as pachinko gaming machine, pachi-lot and the like, in addition to the gaming machine 1 of the above embodiment. In addition, the invention can be applied to a game program which pseudo-executes the operations in the gaming machine 1 described above as a home gaming machine. In this case, a medium for recording the game program may include a CD-ROM, FD (flexible disk) and the other recording media.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
symbol display means for displaying symbols in plural rows;
start operation detection means for detecting a start operation by a player;
internal winning combination determination means for determining an internal winning combination, based on internal winning combination determining information, on condition that the start operation is detected by the start operation detection means;
symbol varying means for varying symbols to be displayed in the plural rows by the symbol display means, on condition that the start operation is detected by the start operation detection means;
stop operation detection means for detecting a stop operation by the player;
stop control means for carrying out a stop control of the symbol variation carried out by the symbol varying means, based on the detection of the stop operation carried out by the stop operation detection means and an internal winning combination determined by the internal winning combination determining means; and
number information storing means for storing information of the number of unit games provided to correspond to each of the plural symbol combinations, on condition that all internal winning combinations corresponding to each of predetermined plural symbol combinations are determined, on condition of the detection of one start operation carried out by the start operation detection means, by the internal winning combination determining means and one of the plural symbol combinations is displayed by the symbol display means,
wherein the internal winning combination determining information provided for the internal winning combination determining means to determine an internal winning combination comprises the first internal winning combination determining information in which a probability that a specific combination, in which a specific symbol combination is matched to a payout allowing the player to play a unit game without consuming a game value, will be determined is a first probability, and the second internal winning combination determining information in which the probability that the specific combination will be determined is a second probability greater than the first probability,
wherein a kind of each of symbols constituting each of the plural symbol combinations is different with regard to only a symbol in one of the plural rows, and the number of symbols capable of being successively displayed by the symbol display means in the one row is different, and
wherein the information of the number of unit games provided to correspond to each of the plural symbol combinations is constituted to be different depending on the plural symbol combinations and the internal winning combination determining means determines an internal winning combination, based on the second internal winning combination determining information, while the unit games are conducted as the information of the number of unit games stored by the number information storing means.

2. The gaming machine according to claim 1, further comprising means for operating a special gaming state, on condition that a predetermined symbol combination corresponding to a predetermined combination is displayed by the symbol display means, wherein a probability that the predetermined combination will be determined is same in the first internal winning combination determining information and the second internal winning combination determining information.

3. The gamine machine according to claim 1, wherein the information of the number of unit games provided to correspond to each of the plural symbol combinations the is such constituted that the information of the number of unit games corresponding to a symbol combination constituted by the symbols having the smaller number capable of being successively displayed, among the plural symbol combinations, is more than the information of the number of unit games corresponding to a symbol combination constituted by the symbols having the greater number capable of being successively displayed, among the plural symbol combinations.

4. The gaming machine according to claim 1, wherein a sliding-display-number, which is the number of symbols to be displayed by the symbol display means during a time period from after the detection of the stop operation is carried out by the stop operation detection means until the stop control of the symbol variation is carried out by the stop control means, is constituted to be smaller with regard to the symbol having the smaller number capable of being successively displayed.
